(19) United States
(12) Patent Application Publication
(10) Pub. No.: US 2003/0051040 A1
(43) Pub. Date: Mar. 13, 2003

(54) Internet appliance terminal, internet appliance terminal user management system, and internet appliance user management program

(75) Inventors: Seijun Tanikawa, Kawasaki (JP); Toshihisa Nakamura, Kawasaki (JP); Hiroshi Oki, Kawasaki (JP); Akio Munakata, Kawasaki (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 10/082,112

(22) Filed: Feb. 26, 2002

(30) Foreign Application Priority Data
Aug. 28, 2001 (JP) 2001-257477

(51) Int. Cl. G06F 15/16

(52) U.S. Cl. 709/229

(57) ABSTRACT

It is possible to provide an IA terminal user management system and a program for said system which comprises: a unit which stores IA terminal information including an IA terminal identifier for identifying an IA terminal, service information including the kind of service to be received, and user registration information including user information concerning the user who receives the service; a unit which transmits and receives user registration information to and from the IA terminal, and requests the IA terminal to input user registration information; a unit which collates the received user registration information with the stored user registration information, and a unit which obtains user registration information which is not collated from the IA terminal and registers said information.

### BACKGROUND OF THE INVENTION

1. Field of the Invention

The present invention relates to a management method of an Internet appliance terminal which is required when maintenance and additional service of various types of IA terminals used at home and in industry are provided, and more specifically to an Internet appliance terminal user management system and an Internet appliance terminal user management program by which users who are not acquainted with Internet appliance terminals or who use Internet appliance terminals for the first time can easily register these IA terminals and their own information.

2. Description of the Related Art

With the advance of the Internet environment in the recent years, Internet appliance terminals which can be connected to the Internet (IA terminal: Internet Appliance terminal) have continuously increased. However, the progress of technology is so fast that the functions which IA terminals originally had are prone to become obsolete so soon.

To fill up this disadvantage, a method in which the state of an IA terminal is registered into a center (an IA terminal user management system), data required to change said state to an up-to-date state is automatically extracted in the center, and the data is supplied to the IA terminal has been developed.

However, the registration procedure for a user to register the state of an IA terminal into the center differed in the past depending on each distribution method of IA terminals, so that the registration operation was difficult to people other than those who are acquainted with IA terminals. Also, in order to make users' operation easy, it was necessary to prepare a dedicated IA terminal itself and dedicated software for controlling an IA terminal according to the distribution method of the IA terminal used.

For example, the distribution method of an IA terminal was such a method that when a user purchased an IA terminal from a manufacturer or a dealer, the user had to conclude an Internet connection contract with an Internet service provider (ISP) independently of (regardless of) the IA terminal, and afterwards he had to register the IA terminal by proceeding with the operation interactively with the center via the Internet.

Also, when an ISP or an application service provider (ASP) provides IA terminal together with service, it was necessary to register the information of the IA terminal or the user's information based on the procedure for registration operation indigenous to the IA terminal which is matched with the service that the ISP or ASP provides.

### SUMMARY OF THE INVENTION

The purpose of the present invention is to provide an IA terminal user management system and an IA terminal user management program by which a user who is not acquainted with an IA terminal or a user who uses an IA terminal for the first time can register the information of the IA terminal itself or the user's information without having to change the IA terminal itself or the program for controlling the IA terminal even if the distribution of the IA terminal differs.

The IA terminal user management system of the present invention comprises an IA terminal user storage unit, a transmission and receiving unit on the side of the IA terminal user management system, a user registration information collation unit, and an automatic registration unit.

In the first phase of the present invention, the IA terminal user storage unit stores IA terminal information including an IA terminal identifier for identifying the IA terminal, service information including the kind of the service which the user receives, and user registration information including user information concerning the user who receives the service. The transmission and receiving unit on the side of the IA terminal user management system transmits and receives user registration information to and from the IA terminal, and requests the IA terminal to input user registration information. The user registration information collation unit collates the user registration information received by the transmission and receiving unit on the side the IA terminal user management system with the user registration information stored in the IA terminal user storage unit. The automatic registration unit obtains the user registration information which was not collated by the user registration information collation unit from the IA terminal via the transmission and receiving unit on the side of the IA terminal user management system, and registers said information into the IA terminal user storage unit.

Also, the IA terminal of the present invention comprises an IA terminal transmission and receiving unit and an input unit.

In the second phase of the present invention, the IA terminal transmission and receiving unit transmits and receives IA terminal information including an IA terminal identifier for identifying the IA terminal, and user registration information including user information concerning the user who receives the service to and from the IA terminal user management system which manages the IA terminal via the above-mentioned network. The input unit inputs insufficient user registration information based on the request from the IA terminal user management system. Also, the transmission and receiving unit on the side of the IA terminal transmits the user registration information inputted by the input unit to the IA terminal user management system.

### BRIEF DESCRIPTION OF THE DRAWINGS

FIG. 1 shows the entire block diagram of the IA terminal user management system to which the present invention applies;

FIG. 2 shows the data structure of the machine table, subscriber table, and affinity table of which an IA terminal user database is composed;

FIG. 3 is a flowchart indicating the flow of the registration processing which is executed in the IA terminal;

FIG. 4 is a flowchart of the erasure processing executed in the IA terminal;

FIG. 5 is a flowchart of the processing executed in the IA terminal user management system;

FIG. 6 is a flowchart indicating the flow of the registration processing of fully automatic registration;

FIG. 7 shows an example (example 1) of the data structure of the machine table, subscriber table, and affinity table in the registration processing of fully automatic registration;

FIG. 8 shows an example (example 2) of the data structure of the machine table, subscriber table, and affinity table in the registration processing of fully automatic registration;

FIG. 9 is a flowchart (flowchart 1) showing the flow of the registration processing of semi-fully automatic registration;

FIG. 10 is a flowchart (flowchart 2) showing the flow of the registration processing of semi-fully automatic registration;

FIG. 11 is a flowchart showing the flow of the registration processing of smart card registration (smart card registration 1);

FIG. 12 is a flowchart (flowchart 1) showing the flow of the registration processing of smart card registration (smart card registration 2);

FIG. 13 is a flowchart (flowchart 2) showing the flow of the registration processing of smart card registration (smart card registration 2);

FIG. 14 is a flowchart (flowchart 1) showing the flow of the registration processing of manually-operated registration (manually-operated registration 1);

FIG. 15 is a flowchart (flowchart 2) showing the flow of the registration processing of manually-operated registration (manually-operated registration 1);

FIG. 16 shows an example (example 1) of the data structure of the machine table, subscriber table, and affinity table in the registration processing of manually-operated registration (manually-operated registration 1);

FIG. 17 shows an example (example 2) of the data structure of the machine table, subscriber table, and affinity table in the registration processing of manually-operated registration (manually-operated registration 1);

FIG. 18 is a flowchart (flowchart 1) showing the flow of the registration processing of manually-operated registration (manually-operated registration 2);

FIG. 19 is a flowchart (flowchart 2) showing the flow of the registration processing of manually-operated registration (manually-operated registration 2);

FIG. 20 shows an example (example 1) of the data structure of the machine table, subscriber table, and affinity table in the registration processing of manually-operated registration (manually-operated registration 2);

FIG. 21 shows an example (example 2) of the data structure of the machine table, subscriber table, and affinity table in the registration processing of manually-operated registration (manually-operated registration 2);

FIG. 22 is a flowchart (flowchart 1) showing the flow of the registration processing of the pattern in which the IA terminal user management system and the ISP server converse;

FIG. 23 is a flowchart (flowchart 2) showing the flow of the registration processing of the pattern in which the IA terminal user management system and the ISP server converse;

FIG. 24 shows an example (example 1) of the data structure of the machine table, subscriber table, and affinity table in the registration processing of the pattern in which the IA terminal user management system and the ISP server converse;

FIG. 25 shows an example (example 2) of the data structure of the machine table, subscriber table, and affinity table in the registration processing of the pattern in which the IA terminal user management system and the ISP server converse;

FIG. 26 is a flowchart showing the flow of the registration processing of replacement due to breakdown (replacement 1: SID input not required);

FIG. 27 shows an example (example 1) of the data structure of the machine table, subscriber table, and affinity table in the registration processing of replacement due to breakdown (replacement 1: SID input not required);

FIG. 28 shows an example (example 2) of the data structure of the machine table, subscriber table, and affinity table in the registration processing of replacement due to breakdown (replacement 1: SID input not required);

FIG. 29 shows an example (example 3) of the data structure of the machine table, subscriber table, and affinity table in the registration processing of replacement due to breakdown (replacement 1: SID input not required);

FIG. 30 is a flowchart (flowchart 1) showing the flow of the registration processing of replacement due to breakdown (replacement 2: SID input required);

FIG. 31 is a flowchart (flowchart 2) showing the flow of the registration processing of replacement due to breakdown (replacement 2: SID input required);

FIG. 32 is a flowchart showing the flow of the registration processing of registration erasure;

FIG. 33 shows an example (example 1) of the data structure of the machine table, subscriber table, and affinity table in the registration processing of registration erasure;

FIG. 34 shows an example (example 2) of the data structure of the machine table, subscriber table, and affinity table in the registration processing of registration erasure;

FIG. 35 shows the block diagram of the IA terminal and the IA terminal user management system; and

FIG. 36 shows the loading of the program of the present invention onto a computer.

### DESCRIPTION OF THE PREFERRED EMBODIMENTS

Described below are the embodiments of the present invention with reference to the accompanying drawings.

A plurality of patterns can be considered for the registration of an IA terminal (the procedure for beginning the utilization). Then, a registration protocol which can cope with a plurality of patterns has been prepared, and a packaging of the DB layout and the IA terminal on the side of the server to realize this registration protocol has been prepared.

In order to solve the above-mentioned problem, the present invention employs the following constitution.

According to an embodiment of the present invention, the IA terminal user management system of the present invention is an IA terminal user management system which manages IA terminals connected via a network, and it comprises an IA terminal user storage unit which stores IA terminal information including an IA terminal identifier for identifying the IA terminal, service information including the kind of service to be provided, and user registration information including user information concerning the user who receives the service; a transmission and receiving unit on the side of the IA terminal user management system which transmits and receives the user registration information from and to the IA terminal, and requests the IA terminal to input the user registration information; a user registration information collation unit which collates the user registration information received by the transmission and receiving unit on the side of the IA terminal user management system with the user registration information stored in the IA terminal user storage unit; and an automatic registration unit which obtains the user registration information which was not collated by the user registration information collation unit from the IA terminal via the transmission and receiving unit on the side of the IA terminal user management system, and registers the said user registration information in the IA terminal user storage unit.

It is thereby made possible for a user who is not acquainted with IA terminals or a user who uses IA terminals for the first time to easily register an IA terminal and his own information without changing the IA terminal or the software for controlling the IA terminal.

Also, in the IA terminal user management system of the present invention, it is desirable for the transmission and receiving unit on the side of the IA terminal user management system to receive the user registration information including the IA terminal identifier from the IA terminal; for the user registration information collation unit to collate the received user registration information with the user registration information stored in the IA terminal user storage unit; for the transmission and receiving unit on the side of the IA terminal user management system to transmit the collated result to the IA terminal; for the transmission and receiving unit on the side of the IA terminal user management system to receive additional user registration information which is not included in the received user registration information, from the IA terminal; and for the automatic registration unit to register the received additional user registration information into the IA terminal user storage unit.

Also, in the IA terminal user management system of the present invention, it is desirable for the IA terminal user storage unit to comprise a machine table which stores the IA terminal identifier in association with the user identifier for identifying the user; a subscriber table which stores the user identifier in association with the service provider identifier for identifying the service provider who provides the service; and an affinity table which stores the service provider identifier in association with the registration procedure for user registration determined by the service provider.

Also, in the IA terminal user management system of the present invention, it is desirable for the automatic registration unit to delete user registration information stored in the IA terminal user storage unit.

Also, according to an embodiment of the present invention, the IA terminal of the present invention is an IA terminal which performs information communication via a network, and it comprises a transmission and receiving unit on the side of the IA terminal which transmits and receives, via a network, IA terminal information including an IA terminal identifier for identifying the IA terminal, service information including the kind of service received, and user registration information including user information concerning the user who receives the service to and from the IA terminal user management system which manages the IA terminal; and an input unit which inputs insufficient user registration information based on the request from the IA terminal user management system, whereas the transmission and receiving unit on the side of the IA terminal transmits the user registration information inputted by the input unit to IA terminal user management system.

It is thereby made possible for a user who is not acquainted with IA terminals or a user who uses IA terminals for the first time to easily register an IA terminal and his own information into the IA terminal user management system without changing the IA terminal or the software for controlling the IA terminal.

Also, in the IA terminal of the present invention, it is desirable for the transmission and receiving unit on the side of the IA terminal to transmit user registration information including the IA terminal identifier; for the transmission and receiving unit on the side of the IA terminal to receive the results of having collated the transmitted user registration information with the user registration information stored in the IA terminal user storage unit provided in the IA terminal user management system from the IA terminal user management system; for the input unit to input additional user registration information which is not included in the received user registration information; for the transmission and receiving unit on the side of the IA terminal to transmit the inputted additional user registration information to the IA terminal user management system.

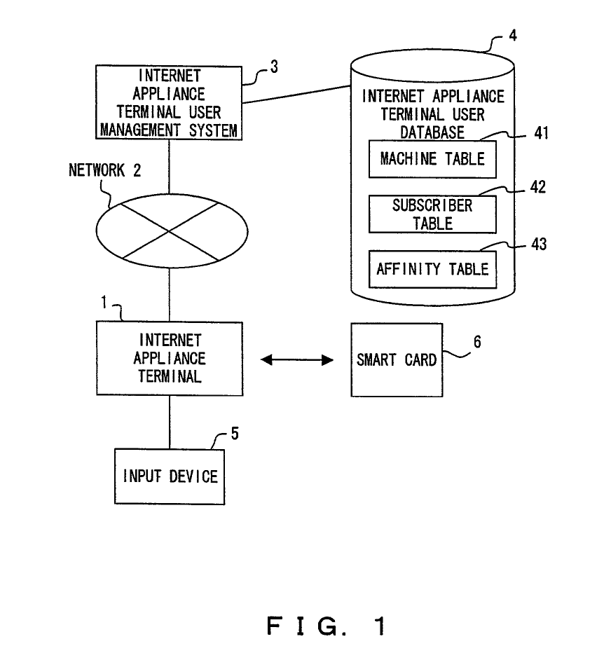

FIG. 1 shows the block diagram of the entire system including the IA terminal and IA terminal user management system to which the present invention applies.

In FIG. 1, the IA terminal 1 which performs information communication and the IA terminal user management system 3 which manages the IA terminal 1 are connected to each other via a network of the Internet, etc.

The IA terminal 1 comprises a transmission and receiving unit on the side of the IA terminal which transmits and receives, via the network 2, IA terminal information including an IA terminal identifier for identifying the IA terminal, service information including the kind of service to be received, and user registration information including user information concerning the user who receives the service to and from the IA terminal user management system 3 which manages the IA terminal 1; and an input unit 5 such as a key board which inputs insufficient user registration information based on the request from the IA terminal user management system, and the IA terminal 1 can read the information stored in the smart card 6.

The transmission and receiving unit on the side of the IA terminal transmits the user registration information read from the smart card 6 and the user registration information inputted by the input unit 5 to the IA terminal user management system 3.

Also, the transmission and receiving unit on the side of the IA terminal transmits the user registration information including the IA terminal identifier to the IA terminal user management system 3 and receives the results of having collated the transmitted user registration information with the user registration information stored in the IA terminal user database 4 provided in the IA terminal user management system 3 from the IA terminal user management system 3.

The input unit 5 inputs additional user registration information which is not included in the received user registration information, and the transmission and receiving unit on the side of the IA terminal transmits the inputted additional user registration information to the IA terminal user management system 3.

The IA terminal user management system 3 has an IA terminal user database 4 which stores IA terminal information including an IA terminal identifier for identifying the IA terminal 1, service information including the kind of service to be provided, and user registration information including user information concerning the user who receives the service.

The IA terminal user database 4 has a machine table 41 which stores the IA terminal identifier in association with the user identifier for identifying the user, a subscriber table 42 which stores the user identifier in association with a service provider identifier for identifying the service provider who provides the service, and an affinity table 43 which stores the service provider identifier in association with the registration procedure for user registration determined by the service provider.

Also, the IA terminal user management system 3 transmits and receives the user registration information from and to the IA terminal 1, and the IA terminal user management system 3 comprises a transmission and receiving unit on the side of the IA terminal user management system which requests the IA terminal 1 to input the user registration information, a user registration collation unit which collates the user registration information received by the transmission and receiving unit on the side of the IA terminal user management system with the user registration information stored in the IA terminal user database 4, and an automatic registration unit which obtains the user registration information which was not collated by the user registration information collation unit from the IA terminal 1 via the transmission and receiving unit on the side of the IA terminal user management system and registers said user registration information into the IA terminal user database 4.

The transmission and receiving unit on the side of the IA terminal user management system receives user registration information including the IA terminal identifier from the IA terminal 1, and the user registration information collation unit collates the received user registration information with the user registration information stored in the IA terminal user database 4. The transmission and receiving unit on the side of the IA terminal user management system transmits the collated results to the IA terminal 1, and receives the additional user registration information which is not included in the received user registration information from the IA terminal.

Also, the automatic registration unit registers the received additional user registration information into the IA terminal user database 4, and deletes the user registration information stored in the IA terminal user database 4.

The IA terminal user management system 3 which is configured in such a way as mentioned above receives known information (information which the IA terminal 1 has, or information read from the smart card 6 in some cases) from the IA terminal 1, and tries to make user registration as a first step and if not successful (if the registration has not finished), it becomes possible to have the insufficient information inputted from the IA terminal 1.

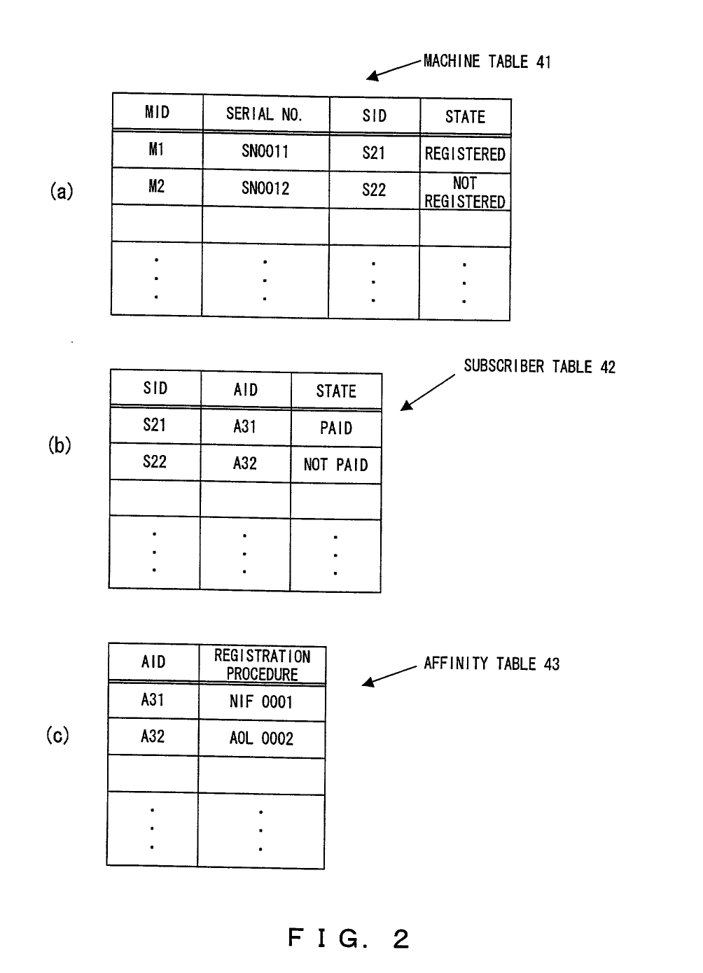

FIG. 2 shows the data structure of the machine table, subscriber table, and affinity table of which the IA terminal user database is composed.

In FIG. 2, (a) shows the data structure of the machine table 41, (b) shows the data structure of the subscriber table 42, and (c) shows the data structure of the affinity table 43.

“MID” in the machine table 41 is the machine identifier (Machine Identifier) given to uniquely identify the IA terminal 1 as hardware. “Serial No.” is the serial number given to the IA terminal 1 by its provider (its manufacturer or its seller). “SID” is the subscriber identifier (Subscriber Identifier) given to uniquely identify the user (the unit of charge for the IA terminal 1) who uses the IA terminal 1. “State” is the state of the IA terminal 1 (namely, registered, not yet registered, breakdown, etc.).

“SID” in the subscriber table 42 is the subscriber identifier given to uniquely identify the user who uses the IA terminal 1, as is the case with “SID” in the machine table 41. “AID” in the subscriber table 42 is the affinity identifier (Affinity Identifier) given to uniquely identify the combination of an Internet service provider (ISP: Internet Service Provider) which the user of the IA terminal 1 uses and an application service provider (ASP: Application Service provider). “State” in the subscriber table 42 is the state of the service which ISP or ASP provides.

“AID” in the affinity table 43 is the affinity identifier given to uniquely identify the combination of ISP and ASP which the user of the IA terminal 1 uses, as is the case with “AID” in the subscriber table 42.

“Registration procedure” is the contents of the procedure for user registration.

The IA terminal user database 4 which is composed of said items is managed by the IA terminal user management system 3.

Also, information (data) is registered in said items in advance according to various kinds of registration processing patterns which will be described later.

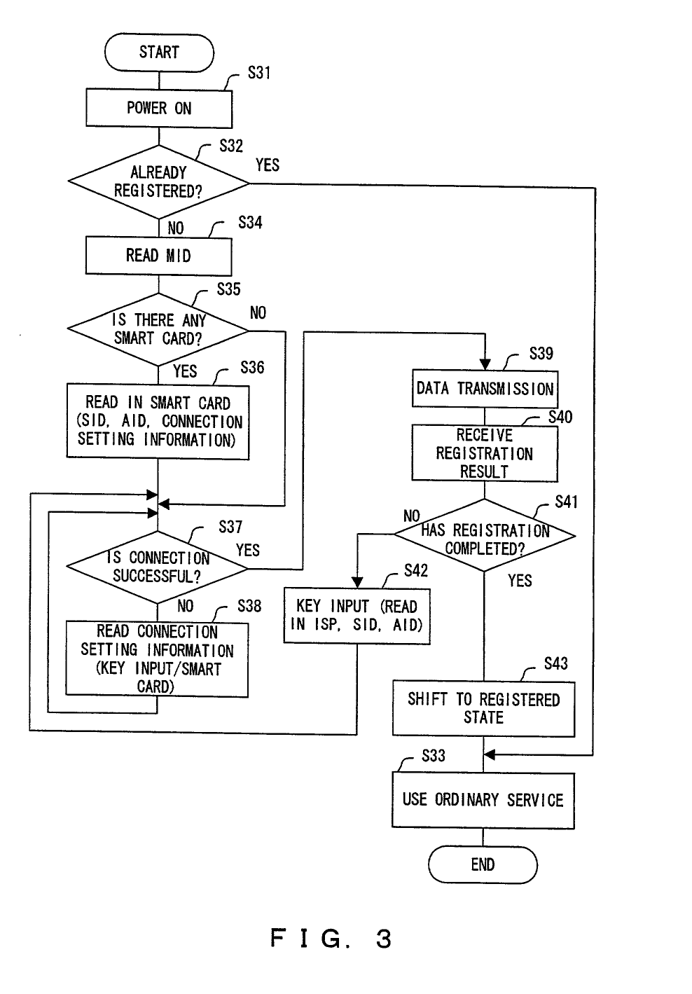

FIG. 3 is a flowchart indicating the flow of the registration processing which is executed in the IA terminal.

First, turn on the power supply of the IA terminal 1 in step S31.

Then, watch the registered flag (which is the flag indicating whether user registration has been made, and indicating 1 if already registered, and 0 if not yet registered) stored in the internal memory of the IA terminal 1, and judge whether user registration has been made, in step S32.

If it is judged that user registration has not been made yet in step S32 (step S32: NO), use ordinary service provided by ISP or ASP via the network 2.

If it is judged that user registration has already been made in step S32 (step S32: YES), read a machine identifier (MID: Machine Identifier) for uniquely identifying the IA terminal 1 as hardware in step S34.

Then, judge whether there is a smart card (for example, whether the AI terminal 1 is provided with a device which reads a smart card, or whether a smart card has been inserted into the AI terminal 1) in step S35.

If it is judged that there is no smart card (step 35: NO), proceed to step S37.

If it is judged that there is a smart card in step S35 (step 35: YES), read the information including a subscriber identifier (SID: Subscriber Identifier) given to uniquely identify the user (unit of charge for the AI terminal 1) who uses the AI terminal 1, an affinity identifier (AID: Affinity Identifier) given to uniquely identify the combination of ISP and ASP which the user of the information home appliance 1 uses, and the connection setting information which is the setting information for connecting the information home appliance to the IA terminal user management device 3, which is all stored in the smart card, in step S36.

After reading the information which is stored in the smart card in step S36, or after it is judged that there is no smart card in step S35, try to connect the IA terminal to the IA terminal user management system 3, and judge whether the connection to the IA terminal user management system 3 is successful in step S37.

If it is not judged the connection is successful (or if it is judged that the connection failed)(step S37: NO), input the connection setting information from an input device such as a keyboard (or read the smart card again), and try to do the connection again.

If it is judged that the connection is successful in step S37 (step S37:YES), transmit data required for user registration to the IA terminal management 3 in step S39, and receive registration results from the IA terminal user management system 3.

Then, judge whether the user registration has been completed in step S41.

If it is judged that the user registration has not been completed (if it is judged that data required for registration is short) in step S41 (step S41: NO), input the short data required for registration (ISP, SID, AID, etc.) from an input device such as a keyboard in step S42, and try to connect the IA terminal 1 to the IA terminal user management system 3 again.

If it is judged that the user registration has been completed in step S41 (step S41: YES), shift to an “registered” state the contents of the IA terminal user database 4 with which the IA terminal user management system 3 is provided in step S43.

Then, use ordinary service which is provided from ISP ASP via a network (step S33).

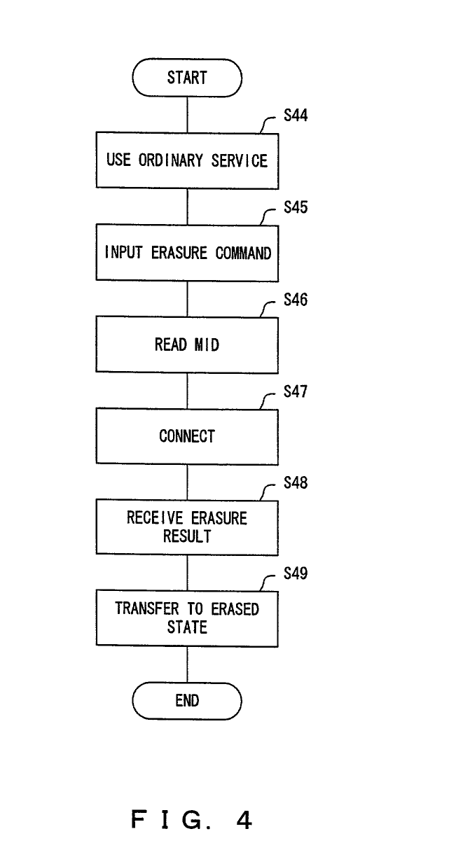

FIG. 4 is a flowchart of the erasure processing executed by the IA terminal.

Ordinary service which is provided from ISP and ASP via a network is used in step S44.

Input commands for erasing the user registration in step S45 and read MID in step S46.

Next, connect the IA terminal 1 to the IA terminal user management system 3 in step S47, and transmit the erasure commands inputted in step S45 and MID read step S46.

Then, since the erasure result is transmitted from the IA terminal user management system 3, receive the transmitted erasure result in step S48 and shift to an erased state the contents of the IA terminal user database 4 with which the IA terminal user management device 3 is provided.

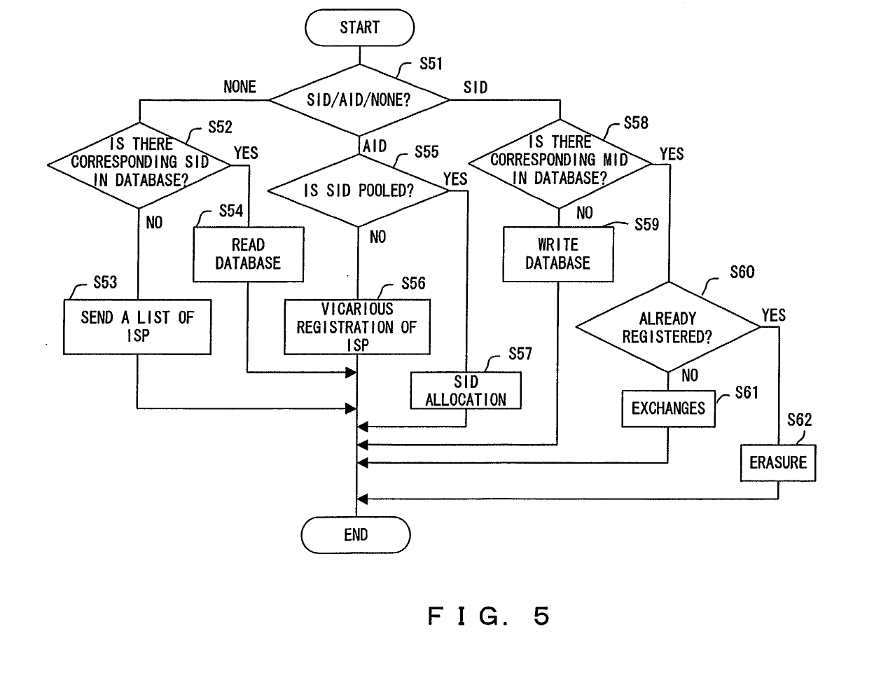

FIG. 5 is a flowchart of the processing executed by the IA terminal user management system.

Judge whether there is SID or AID, or there is no SID, nor AID, in the data transmitted from the IA terminal 1 in step S51.

If it is judged that there is no SID, nor AID in step 51 (step S51: none), judge whether there is SID to which MID corresponds in the IA terminal user database 4 in step S52. If it is judged that there is no such SID in step S52 (step S52: NO), transmit a list of ISP to the IA terminal 1 in step S53.

If it is judged that there is said SID in step S52 (step S52: YES), read the IA terminal user database 4 in step S54.

If it is judged that there is said AID in step S51 (step S51: YES), judge whether SID is pooled in step S55.

If it is judged that SID is not pooled in step S55 (step S55: NO), let ISP (or ASP) interactively make user registration in step S56 (receive the response of MID and AID; take a vicarious procedure for ISP in place of AID; allocate SID to the new user information of the registration result; and associate the SID with MID).

If it is judged that SID is pooled in step S55 (step S55: YES), allocate the SID pooled in each AID to MID in step S57.

If it is judged that there is SID in step S51 (step S51: SID), judge whether there is MID corresponding to the IA terminal database 4 in step S58.

If it is judged that there is no MID in step S58 (step S58: NO), write SID in the IA terminal user database 4 in step S59.

If it is judged that there is MID in step S58 (step S58: YES), judge whether user registration has already been made in step S60.

If it is judged that user registration has not been made yet in step S60 (step S60: NO), exchange data concerning the IA terminal 1 in step S61.

If it is judged that user registration has already been made in step S60 (step S60: YES), erase the data concerning the IA terminal 1 in step S62.

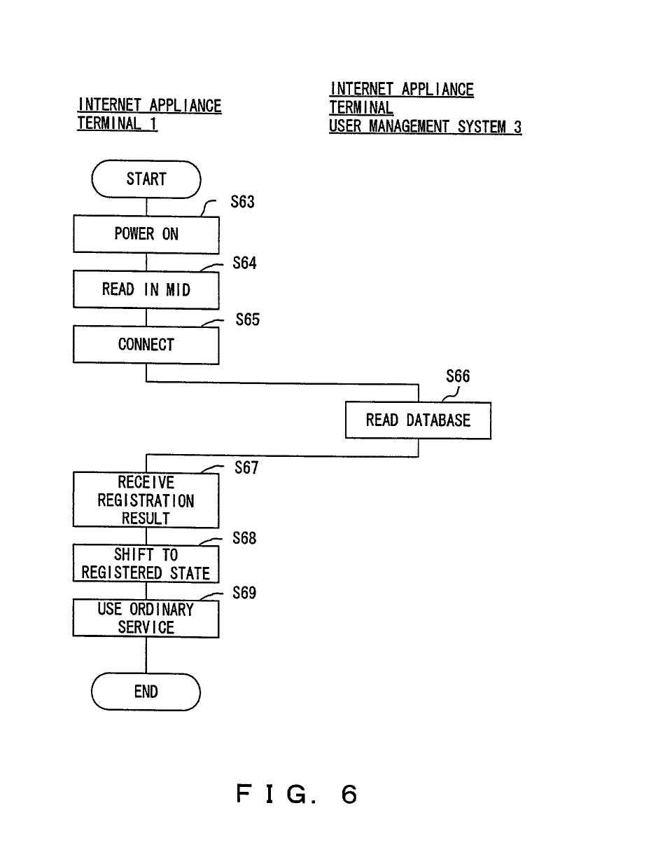

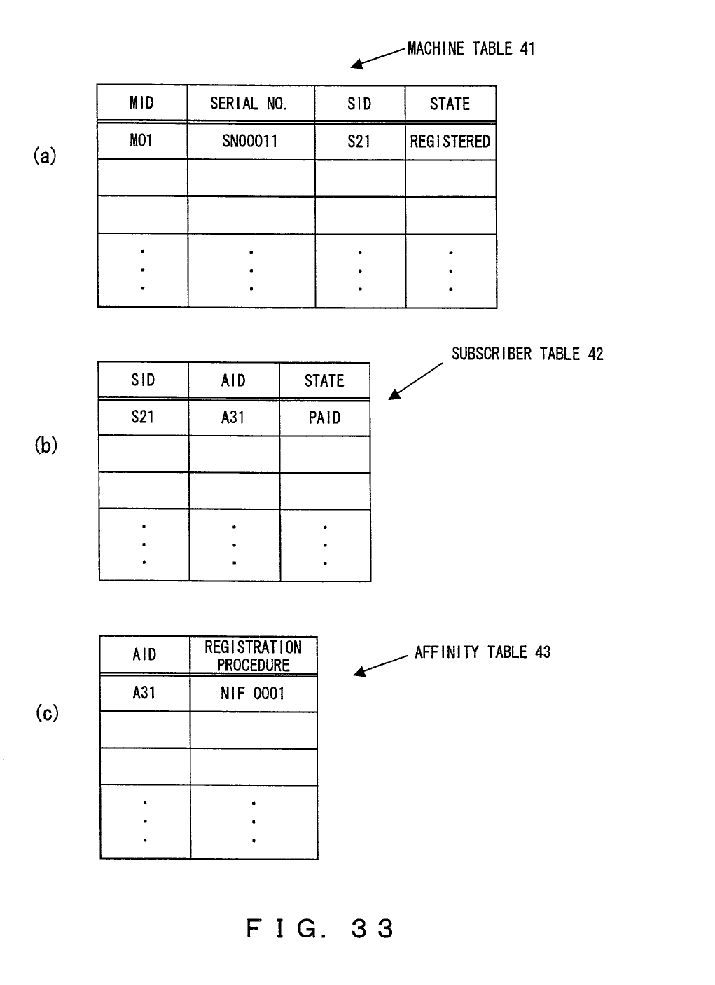

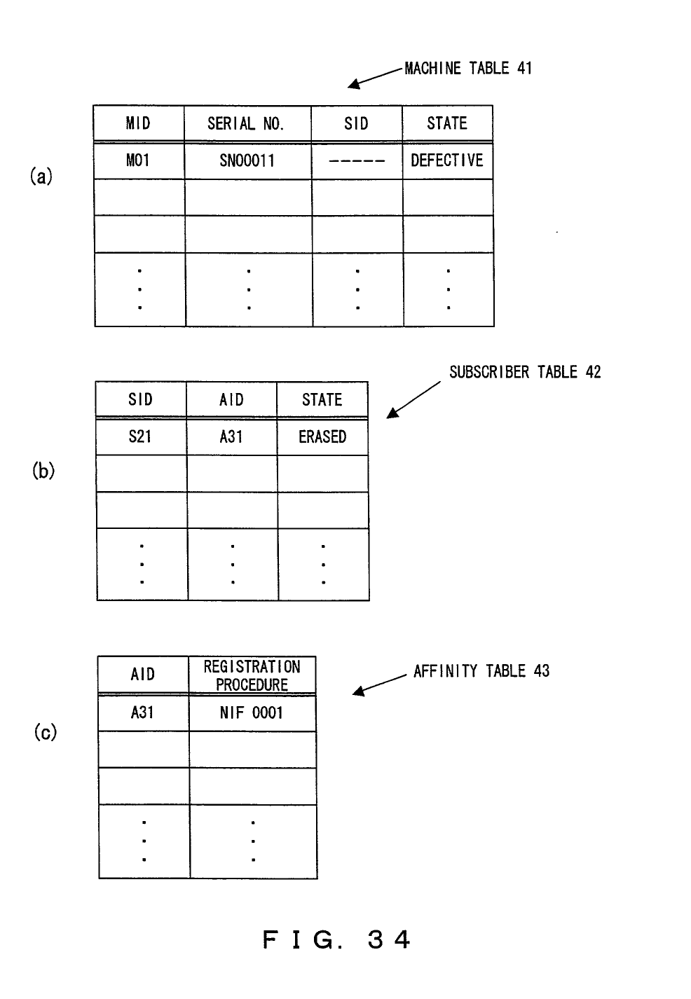

Described below are the first embodiment and the 10th embodiment to which the present invention applies with reference to FIG. 6 through FIG. 34.

Prior to explanations of these embodiments, described hereunder are registration patterns of user registration.

(1) Fully Automatic Registration

Fully automatic registration is executed when an IA terminal can be associated with a user who uses said terminal in advance.

For example, information concerning the IA terminal, the contents of the service that ISP and ASP provides, and information concerning the user who uses the IA terminal are set to the IA terminal user management system in advance, and a specific IA terminal is provided to a specific user according to theses pieces of information (Example 1).

Also, when an IA terminal is delivered to a user at a dealer's shop, information concerning the IA terminal, the contents of the service that ISP and ASP provide, and information concerning the user who uses the IA terminal is set to the IA terminal user management system in advance (Example 2).

(2) Semi-Fully Automatic Registration

Semi-fully automatic registration is executed when an IA terminal can be associated with a user who uses said terminal when user registration is made.

For example, the contents of the service that ISP and ASP provides and information concerning the user who uses the IA terminal are set to the IA terminal user management system in advance, and information of the IA terminal provided to the user is gathered when user registration is made. This is because which IA terminal is provided to the user is unknown.

(3-1) Smart Card Registration (Smart Card Registration 1)

Smart card registration (smart card registration 1) is executed when a smart card recording the information which identifies a user is used.

For example, the service which ISP and ASP provide and information of the user who receives the service is set to the IA terminal user management system in advance, information which identifies the user is recorded in the smart card and is provided to the user in advance, and the information identifying the user in the smart card as well as information of the IA terminal provided to the user are gathered when user registration is made. Although which IA terminal is provided to the user is unknown, the smart card is provided to specific users by means of DM (direct mailing).

(3-2) Smart Card Registration (Smart Card Registration 2)

Smart card registration (smart card registration 2) is executed when a smart card recording the information of ISP and ASP to be used is used.

For example, the service which ISP and ASP provide and information on the user who receives information of this service are set to the IA terminal user management system in advance, information identifying the ISP and ASP to be used and setting information required for connection are recorded in the smart cad and are provided to the user in advance, and information identifying the ISP and ASP to be used and setting information required for connection which are recorded in the smart card as well as information of the IA terminal provided to the user are gathered when user registration is made. Which IA terminal is provided to the user is unknown, and the smart card is common to each user.

| | | |
|---|---|---|
| (4-1) | Manually-operated | registration |
| (manually-operated registration 1) | | |
| | Manually-operated | registration |

(manually-operated registration 1) is executed when information required for SID and connection is manually inputted.

For example, service and information on a provisional user are set to the IA terminal user management system in advance, the information identifying the service and user as well as information of the IA terminal provided to the user are gathered when user registration is made. Although which IA terminal is provided to the user is unknown, information identifying the user and information required for connection can be sent to the user, and the user can manually input these pieces of information.

| | | |
|---|---|---|
| (4-2) | Manually-operated | registration |
| (manually-operated registration 2) | | |
| | Manually-operated | registration |

(manually-operated registration 2) is executed when information on ISP and ASP to be used is manually inputted.

For example, service and information on a provisional user are set to the IA terminal user management system in advance, the information identifying the service as well as information of the IA terminal provided to the user are gathered when user registration is made. Which IA terminal is provided to the user is unknown, and the limit of using the service is pooled in advance.

(5) Pattern in Which the IA Terminal User Management System Converses With the Server of ISP

The pattern in which the IA terminal user management system converses with the server of ISP is executed when ISP and ASP to be used are selected when they are connected to the IA terminal user management system.

For example, nothing is set to the IA terminal user management system in advance, the service which ISP and ASP provide and information identifying the user who receives this service as well as the information of the IA terminal provided to the user are gathered when user registration is made. Which IA terminal is provided to the user is not known, nor is the limit of using the service pooled in advance.

(6) Breakdown Replacement

Breakdown replacement is executed when the IA terminal is replaced for the reason of breakdown, etc.

For example, the IA terminal user management system is informed of the information identifying a new IA terminal as well as user identification information. The IA terminal user management system associates user information which has already been registered with information on the new IA terminal, the state is changed to a “not yet registered” state, and an old terminal appliance terminal which has been associated with the user information which has already been registered is managed as a defective IA terminal. Then, when a fully automatic registration request is made to the IA terminal user management system at a new IA terminal which has not been registered yet, the IA terminal user management system transmits the user information to the IA terminal and changes the state to an “already registered” state.

In order to avoid the leakage of personal information occurring due to the robbery of an IA terminal when it is replaced, when a registration request is made to the IA terminal user management system at a new IA terminal which has not been registered yet, the owner of the IA terminal can be confirmed by manually inputting SID or inserting the smart card which records SID, but this measure can be also provided in the procedure of initial registration.

(7) Registration Erasure

Registration erasure is executed when service has become unused.

For example, the state of the IA terminal which the IA terminal manages is changed to a “not yet registered” state, and information of the IA terminal and user information are transmitted to the IA terminal user management system. The IA terminal user management system releases the association of the IA terminal which is recorded in the IA terminal user database with the user, and stops providing the subsequent service.

Described hereunder is the registration processing of fully automatic registration which is the first embodiment to which the present invention applies with reference to FIG. 6 through FIG. 8.

FIG. 6 is a flowchart indicating the flow of the registration processing of fully automatic registration.

Fully automatic registration means that all the information has already been registered, and the association of MID and SID has been completed.

First, turn on the power supply (ON) of the IA terminal 1 in step S63.

Since the registered flag stored in the internal memory of the IA terminal 1 has not been registered yet (e.g. 0 is stored), read the identifier (MID) given to uniquely identify the IA terminal 1 as hardware in step S64.

Also, connect the IA terminal 1 to the IA terminal user management system 3 in step S65.

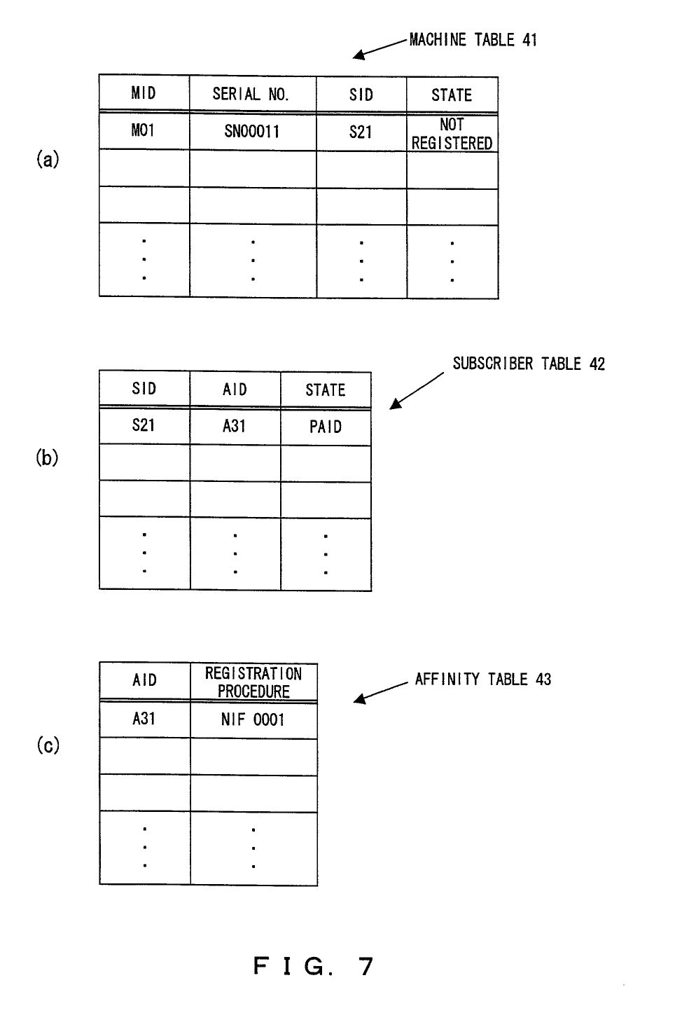

Then, the IA terminal user management system 3 connected to the IA terminal 1 reads the IA terminal user database 4 (refer to FIG. 7) in step S66.

The IA terminal 1 receives the registration result from the IA terminal user management system 3 in step S67.

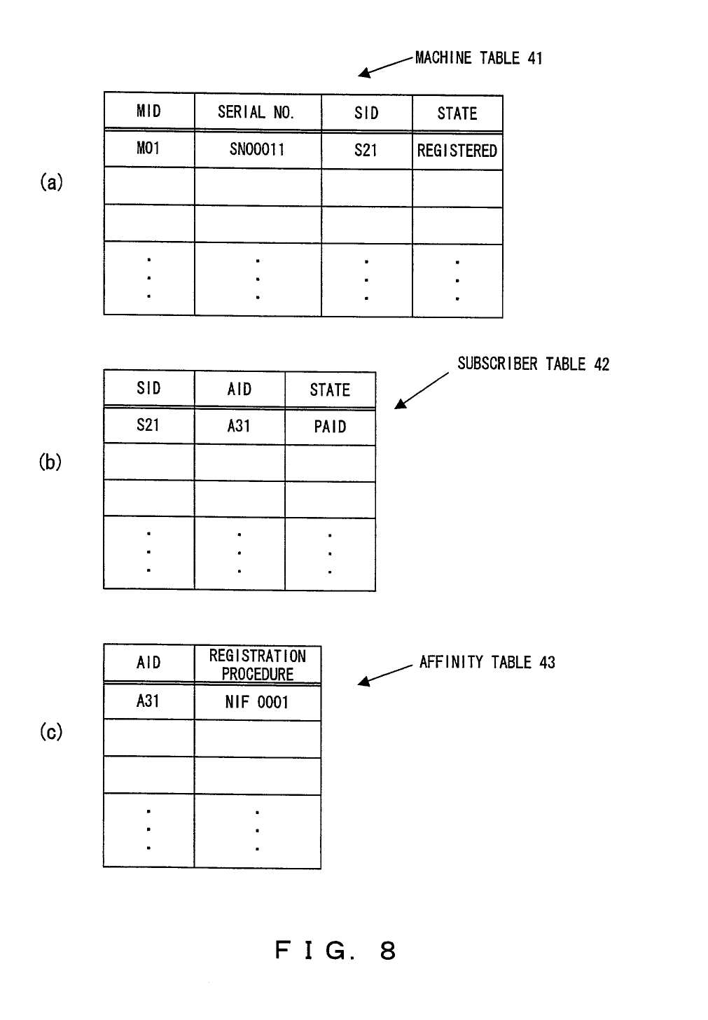

Shift the contents of the IA terminal user database 4 with which the IA terminal user management system 3 is provided to an “registered” state in step S68 (refer to FIG. 8).

After that, use ordinary service provided from ISP and ASP via a network (step S69).

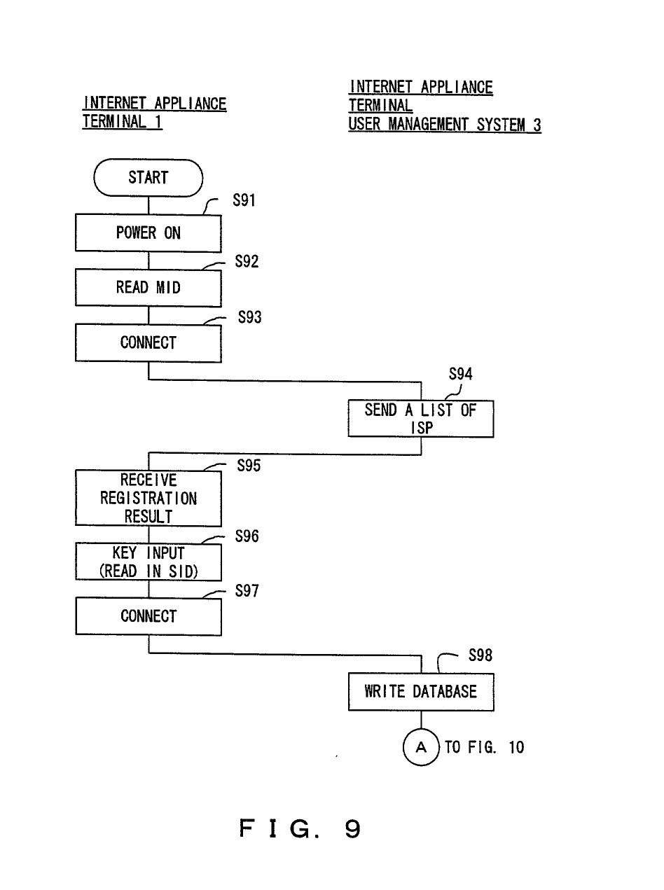

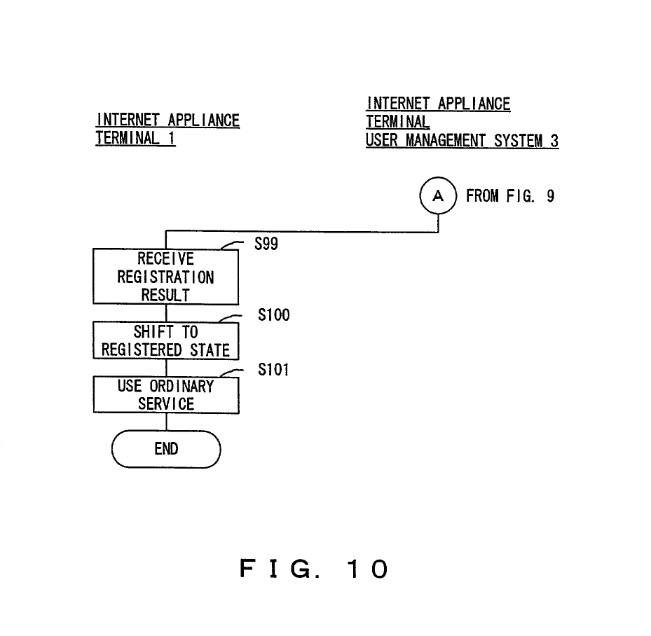

Described hereunder is the registration processing of semi-fully automatic registration which is the second embodiment to which the present invention applies with reference to FIG. 9 and FIG. 10.

FIG. 9 and FIG. 10 are flowcharts showing the flow of the registration processing of semi-fully automatic registration.

First, turn on the power supply of the IA terminal 1 (ON) in step S91.

Since the registered flag stored in the internal memory of the IA terminal 1 has not been registered yet (e.g. 0 is stored), read the identifier (MID) given to uniquely identify the IA terminal 1 as hardware in step S92.

Also, connect the IA terminal 1 to the IA terminal user management system 3 in step S93.

Then, the IA terminal user management system 3 connected to the IA terminal 1 transmits a list of ISP to the IA terminal in step S94.

The IA terminal user management system 3 connected to the IA terminal 1 receives the registration result (a list of ISP) from the IA terminal user management system 3 in step S95.

Since user registration has not been completed yet, input insufficient data (SID) required for user registration from an input device such as a keyboard in step S96.

Connect the IA terminal 1 to the IA terminal user management system 3 again in step S97.

Then, the IA terminal user management system 3 connected to the IA terminal 1 writes in the IA terminal user database 4 in step S98.

The IA terminal 1 receives the registration result from the IA terminal user management system 3 in step 99 (refer to FIG. 10).

Shift the contents of the IA terminal user database 4 with which the IA terminal user management system 3 is provided to an “registered” state in step S110.

After that, use ordinary service provided from ISP and ASP via a network (step S101).

Described below is the smart card registration (smart card registration 1) which is the third embodiment to which the present invention applies.

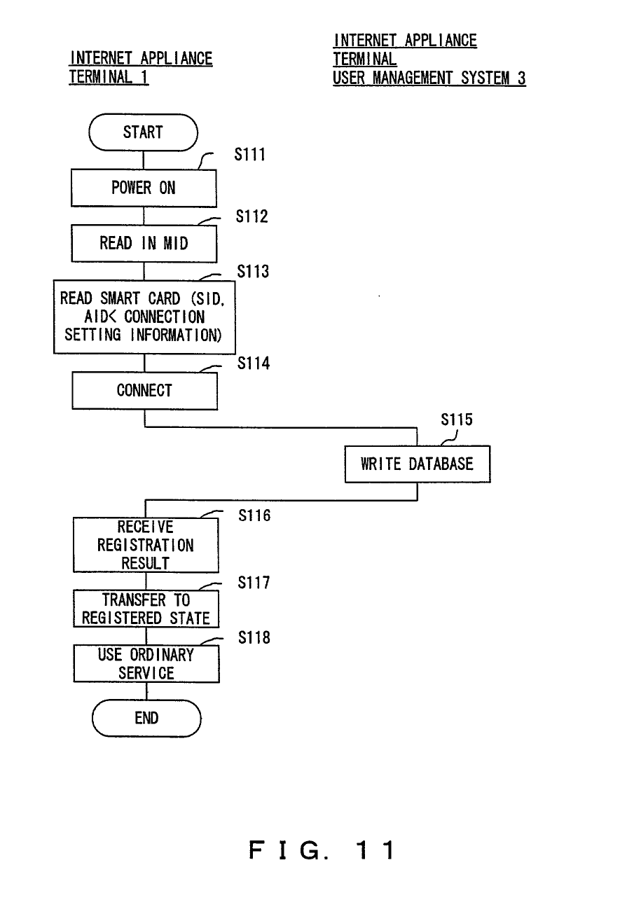

FIG. 11 is a flowchart showing the flow of the registration processing of smart card registration (smart card registration 1).

First, turn on the power supply of the IA terminal 1 (ON) in step S111.

Since the registered flag stored in the internal memory of the IA terminal 1 has not been registered yet (e.g. 0 is stored), read the identifier (MID) given to uniquely identify the IA terminal 1 as hardware in step S112.

Since there is a smart card, read a subscriber identifier (SID) given to uniquely identify the user who uses the IA terminal 1 (the unit of charge for the IA terminal 1) stored in the smart card, an affinity identifier (AID) given to uniquely identify the combination of ISP and ASP which the user of the IA terminal 1 uses, and information including the connection setting information which is setting information for connecting the IA terminal 1 to the IA terminal user management system 3 in step S113.

Then, connect the IA terminal 1 to the IA terminal user management system 3 in step S114.

The IA terminal user management system 3 connected to the IA terminal 1 writes in the IA terminal user database 4 in step S115.

In step S116, the IA terminal 1 receives the registration result from the IA terminal user management system 3.

Shift the contents of the IA terminal user database 4 with which the IA terminal user management system 3 is provided to an “registered” state in step S117.

After that, use ordinary service provided from ISP and ASP via the network 2 (step S118).

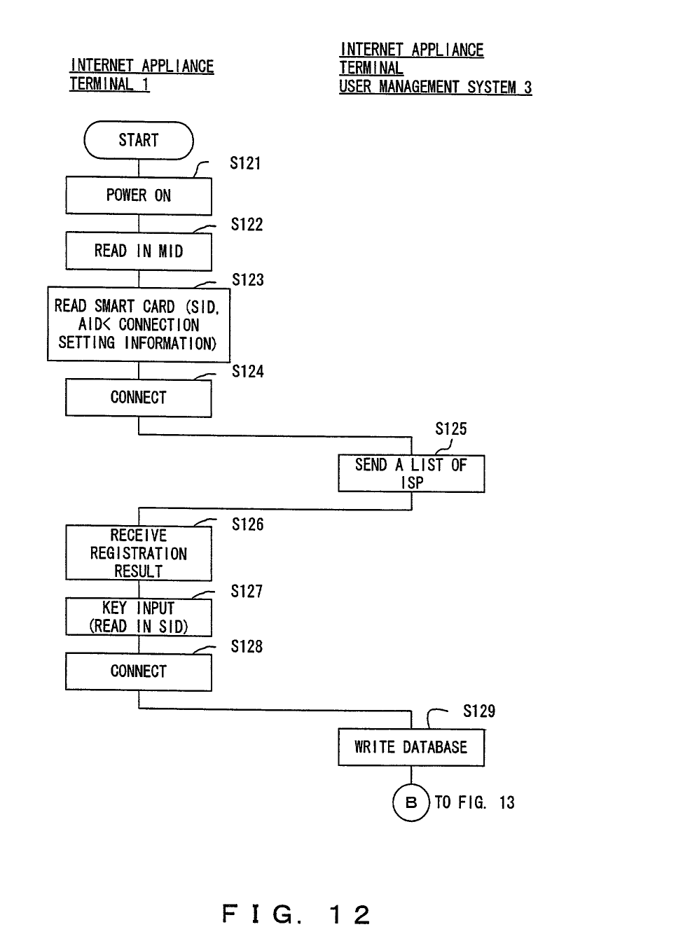

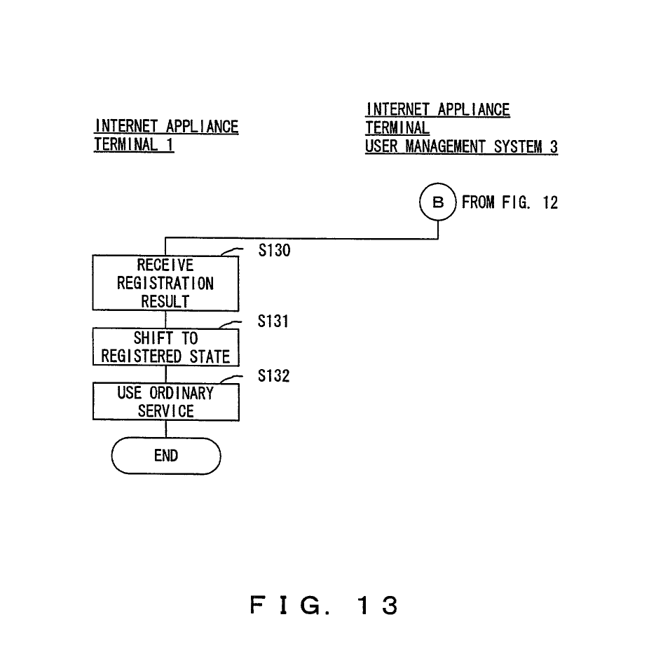

Described hereunder is the smart card registration (smart card registration 2) which is the fourth embodiment to which the present invention applies with reference to FIG. 12 and FIG. 13.

FIG. 12 and FIG. 13 are flowcharts showing the flow of the registration processing of smart card registration (smart card registration 2).

First, turn on the power supply of the IA terminal 1 (ON) in step S121.

Since the registered flag stored in the external memory of the IA terminal has not been registered (e.g. 0 (zero) is stored), read the machine identifier (MID) given to uniquely identify the IA terminal as hardware in step S122.

Since there is a smart card, read a subscriber identifier (SID) given to uniquely identify the user who uses the IA terminal 1 (the unit of charge for the IA terminal 1) stored in the smart card, an affinity identifier (AID) given to uniquely identify the combination of ISP and ASP which the user of the IA terminal 1 uses, and information including the connection setting information which is setting information for connecting the IA terminal 1 to the IA terminal user management system 3 in step S123.

Then, connect the IA terminal 1 to the IA terminal user management system 3 in step S124.

Then, the IA terminal user management system 3 connected to the IA terminal 1 transmits a list of ISP to the IA terminal in step S125.

The IA terminal user management system 3 connected to the IA terminal 1 receives the registration result (a list of ISP) from the IA terminal user management system 3 in step S126.

Since registration has not been completed yet, input insufficient data required for user registration (SID) from an input device such as a keyboard in step S127.

Connect the IA terminal 1 to the IA terminal user management system 3 again in step S128.

Then, the IA terminal user management system 3 connected to the IA terminal 1 writes in the IA terminal terminal user database 4 in step S129.

The IA terminal 1 receives the registration result from the IA terminal user management system 3 in step S130.

Shift the contents of the IA terminal user database 4 with which the IA terminal user management system 3 is provided to an “registered” state in step S131.

After that, use ordinary service provided from ISP and ASP via a network (step S132).

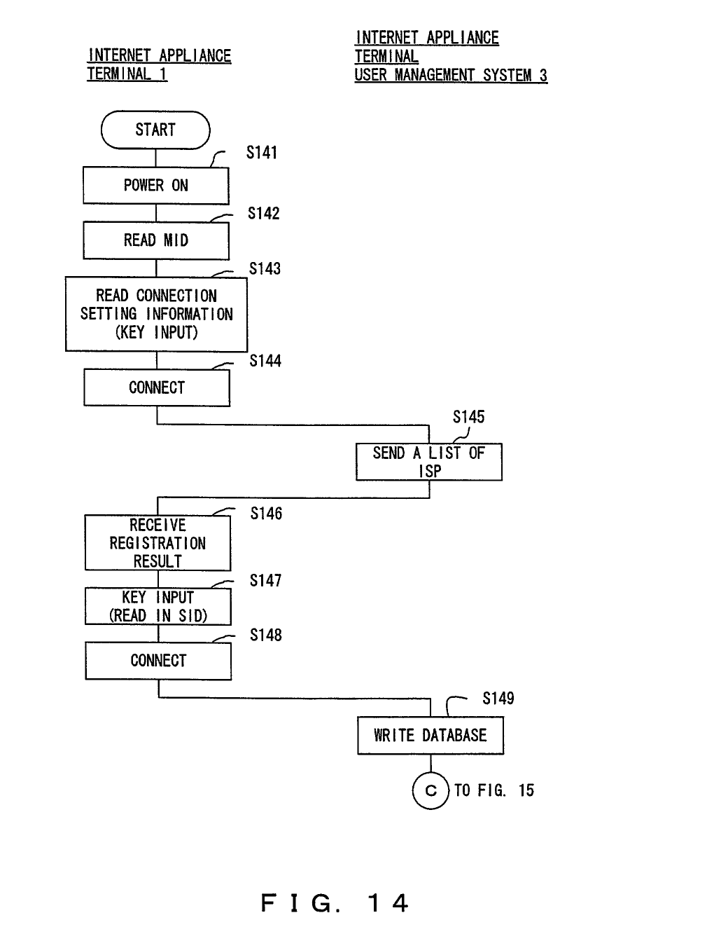

Described hereunder is the manually-operated registration (manually-operated registration 1) which is the fifth embodiment to which the present invention applies with reference to FIG. 14 through FIG. 17.

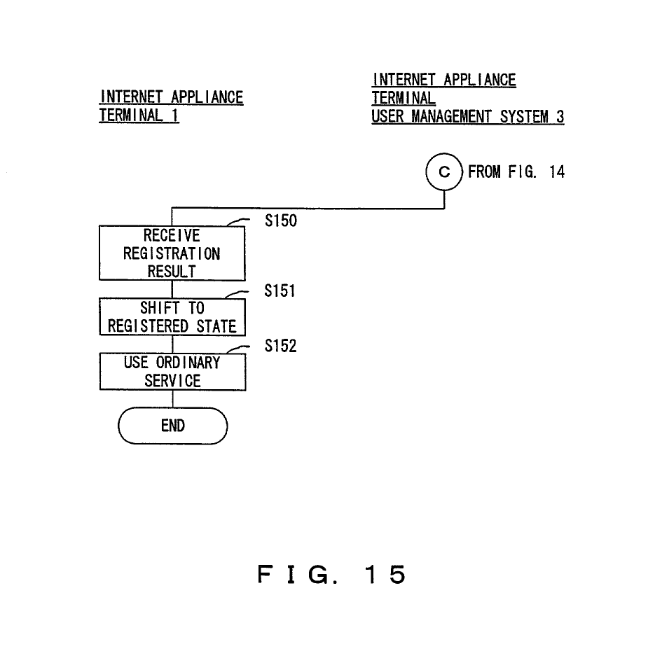

FIG. 14 and FIG. 15 are flowcharts showing the flow of the registration processing of manually-operated registration (manually-operated registration 1).

In the manually-operated registration (manually-operated registration 1), all the information has already been registered, but the association of MID and SID has not been completed.

First, turn on the power supply of the IA terminal 1 (ON) in step S411.

Since the registered flag stored in the internal memory of the IA terminal 1 has not been registered yet (e.g. 0 is stored), read the identifier (MID) given to uniquely identify the IA terminal 1 as hardware in step S142.

Input information including the connection setting information which is the setting information for connecting the IA terminal 1 to the IA terminal user management system 3 from an input device such as a keyboard in step S143.

Connect the IA terminal 1 to the IA terminal user management system 3 in step S144.

Then, the IA terminal user management system 3 connected to the IA terminal 1 transmits a list of ISP to the IA terminal 1 in step S145.

The IA terminal user management system 3 connected to the IA terminal 1 receives the registration result (a list of ISP) from the IA terminal user management system 3 in step S146.

Since user registration has not been completed yet, input insufficient data (SID) required for user registration from an input device such as a keyboard in step S147.

Connect the IA terminal 1 to the IA terminal user management system 3 again in step S148.

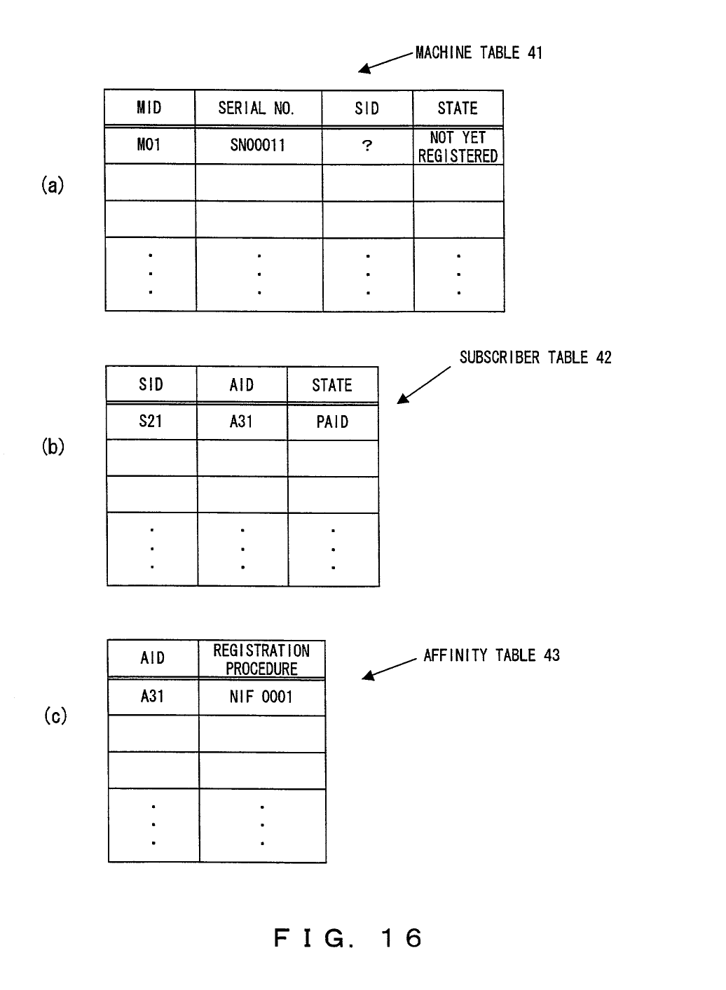

Then, the IA terminal user management system 3 connected to the IA terminal 1 writes in the IA terminal user database 4 in step S149 (refer to FIG. 16).

In FIG. 15, the IA terminal 1 receives the registration result from the IA terminal user management system 3 in step S150.

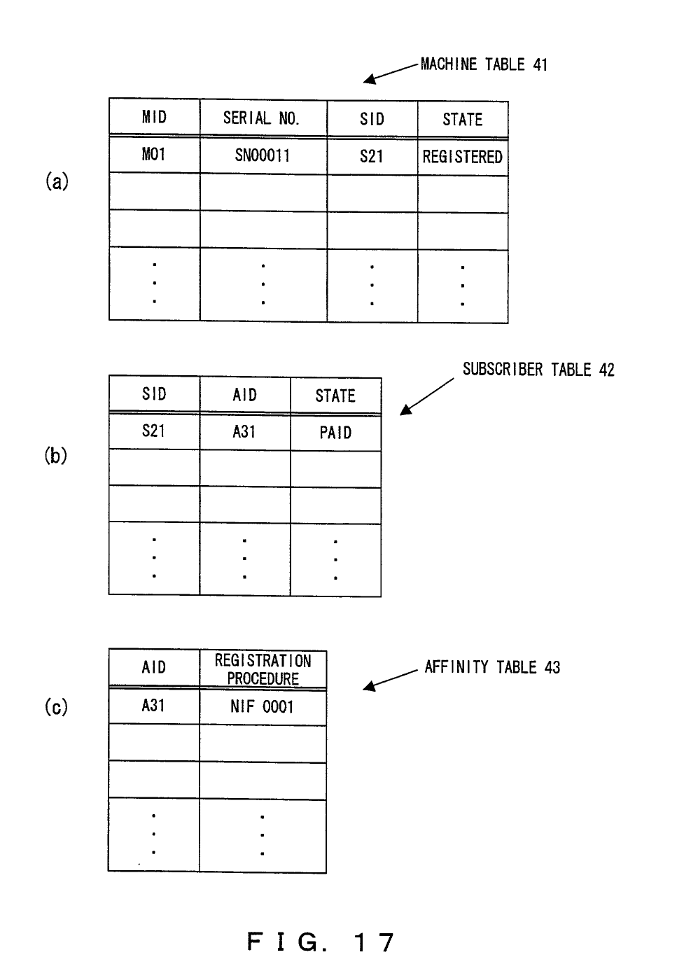

Shift the contents of the IA terminal user database 4 with which the IA terminal user management system 3 is provided to an “registered” state in step S151 (refer to FIG. 17).

After that, use ordinary service provided from ISP and ASP via a network (step S152).

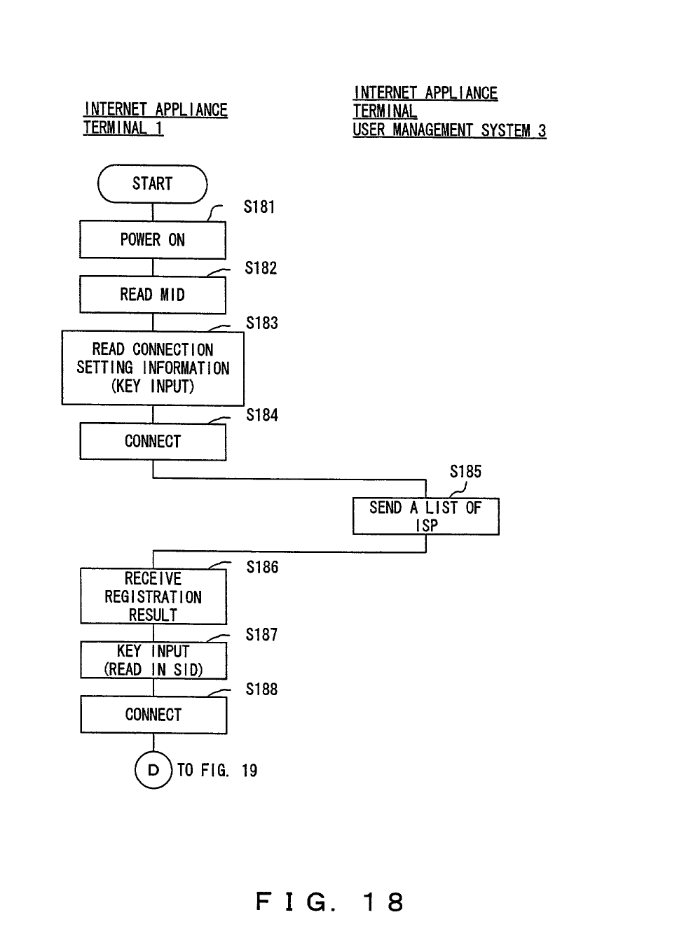

Described hereunder is the manually-operated registration (manually-operated registration 2) which is the sixth embodiment to which the present invention applies with reference to FIG. 18 through FIG. 21.

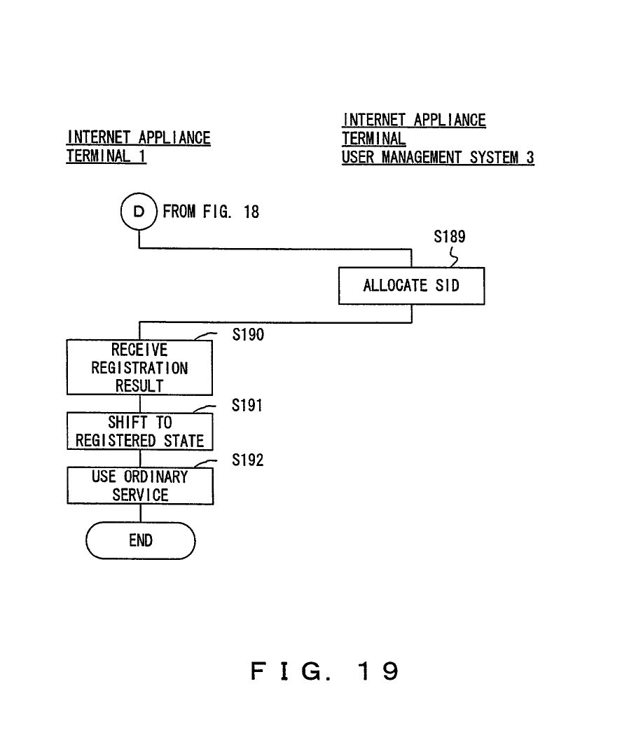

FIG. 18 and FIG. 19 are flowcharts showing the flow of the registration processing of manually-operated registration (manually-operated registration 2).

In the manually-operated registration (manually-operated registration 2), MID has already been registered, but SID is only pooled for each AID.

First, turn on the power supply of the IA terminal 1 (ON) in step S181.

Since the registered flag stored in the internal memory of the IA terminal 1 has not been registered yet (e.g. 0 is stored), read the machine identifier (MID) given to uniquely identify the IA terminal 1 as hardware in step S182.

Input information including the connection setting information which is the setting information for connecting the IA terminal 1 to the IA terminal user management system 3 from an input device such as a keyboard in step S183.

Connect the IA terminal 1 to the IA terminal user management system 3 in step S184.

Then, the IA terminal user management system 3 connected to the IA terminal 1 transmits a list of ISP to the IA terminal 1 in step S185.

The IA terminal user management system 3 connected to the IA terminal 1 receives the registration result (a list of ISP) from the IA terminal user management system 3 in step S186.

Since user registration has not been completed yet, input insufficient data (SID) required for user registration from an input device such as a keyboard in step S187.

Connect the IA terminal 1 to the IA terminal user management system 3 again in step S188.

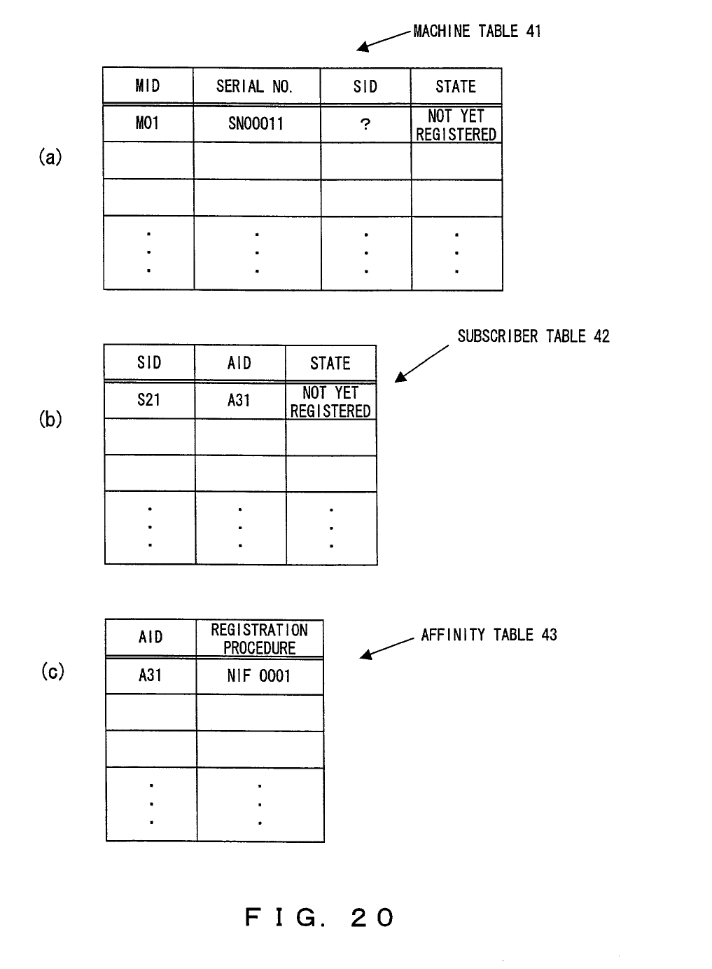

In FIG. 19, the IA terminal user management system 3 connected to the IA terminal 1 receives the correspondence of MID and AID, and allocates the MID pooled for each AID to MID in step 189 (refer to FIG. 20).

The IA terminal 1 receives the registration result from the IA terminal user management system 3 in step S190.

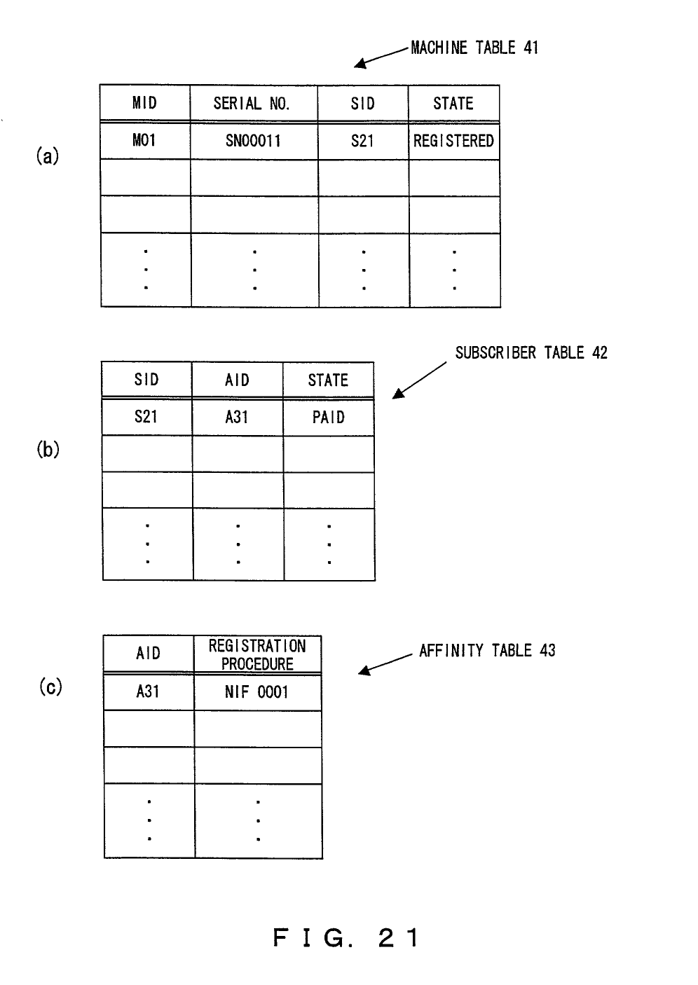

Shift the contents of the IA terminal user database 4 with which the IA terminal user management system 3 is provided to an “registered” state in step S191 (refer to FIG. 21).

After that, use ordinary service provided from ISP and ASP via a network (step S192).

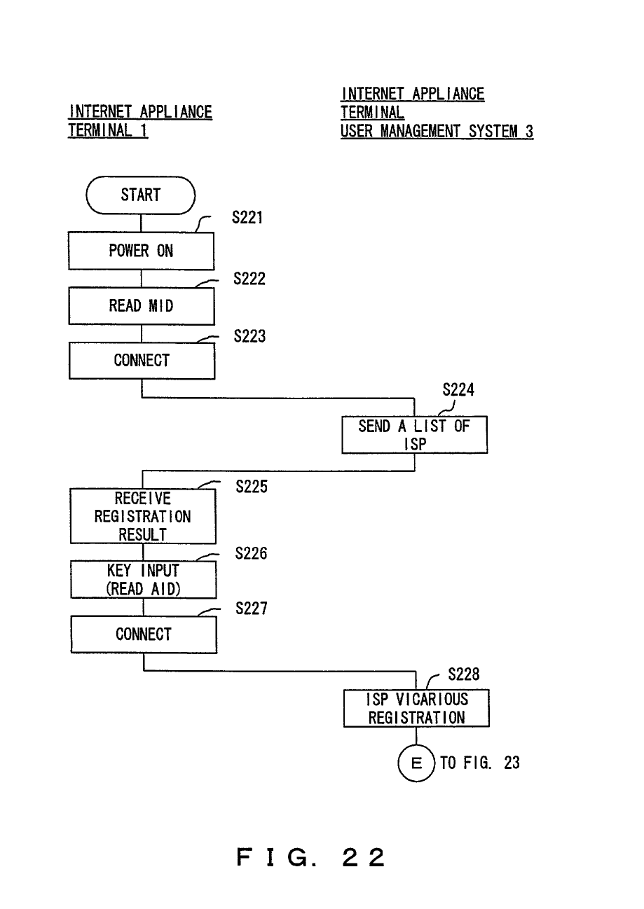

Described next is the pattern in which the IA terminal user management system which is the seventh embodiment to which the present invention applies converses with the server of ISP with reference to FIG. 22 through FIG. 25.

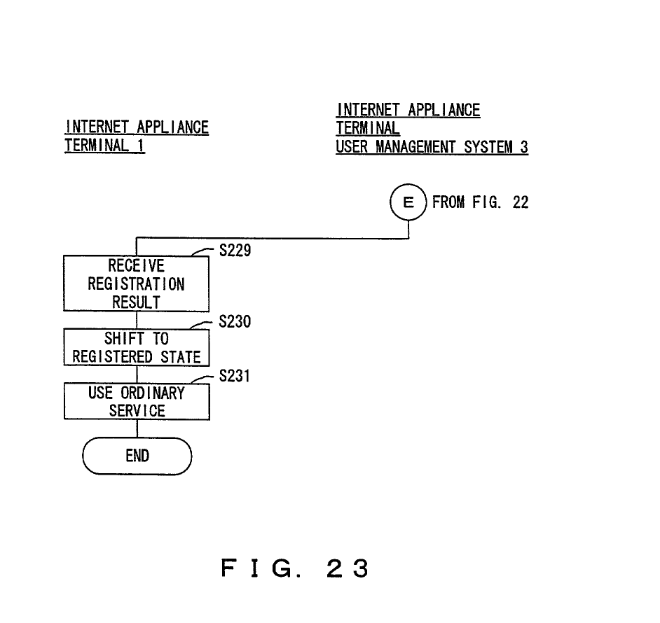

FIG. 22 and FIG. 23 are flowcharts showing the flow of the registration processing of the pattern in which the IA terminal user management system converses with the ISP server.

In the registration processing of the pattern in which the IA terminal user management system converses with the ISP server, MID has already been registered, but SID has not been registered yet.

First, turn on the power supply of the IA terminal 1 (ON) in step S221.

Since the registered flag stored in the internal memory of the IA terminal 1 has not been registered yet (e.g. 0 is stored), read the machine identifier (MID) given to uniquely identify the IA terminal 1 as hardware in step S222.

Connect the IA terminal 1 to the IA terminal user management system 3 in step S223.

Then, the IA terminal user management system 3 connected to the IA terminal 1 transmits a list of ISP to the IA terminal 1 in step S224.

The IA terminal user management system 3 connected to the IA terminal 1 receives the registration result (a list of ISP) from the IA terminal user management system 3 in step S225.

Since registration has not been completed yet, input insufficient data (AID) required for user registration from an input device such as a keyboard in step S226.

Connect the IA terminal 1 to the IA terminal user management system 3 again in step S227.

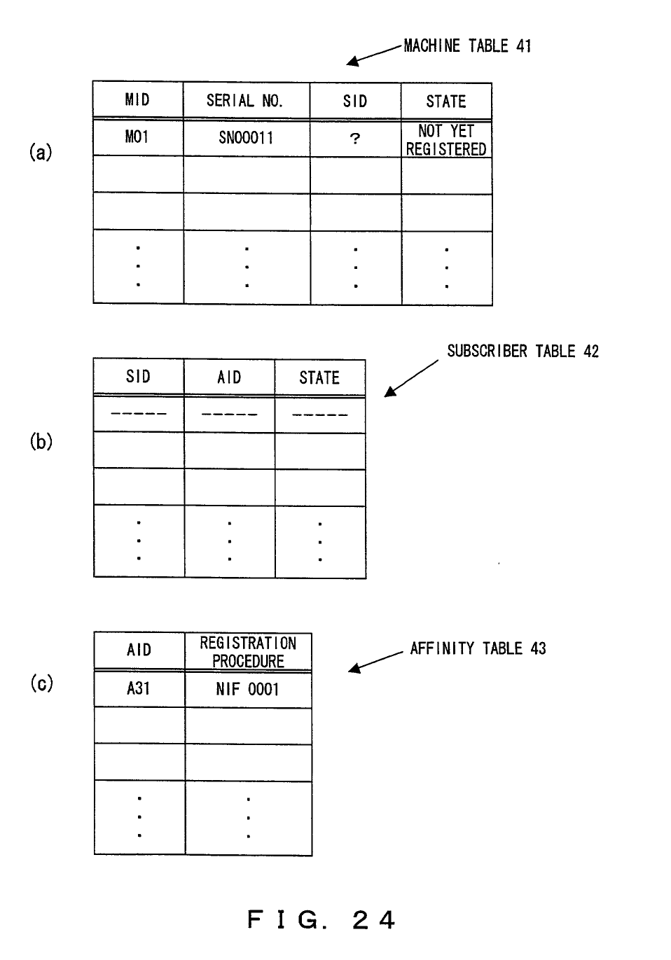

The IA terminal user management system 3 connected to the IA terminal 1 receives the correspondence of MID and AID, carries out a vicarious registration of ISP in place of AID, allocates SID to the new user information of the registration result, and associate the SID with MID in step S228 (refer to FIG. 24).

The IA terminal 1 receives the registration result from the IA terminal user management system 3 in step S229 in FIG. 23.

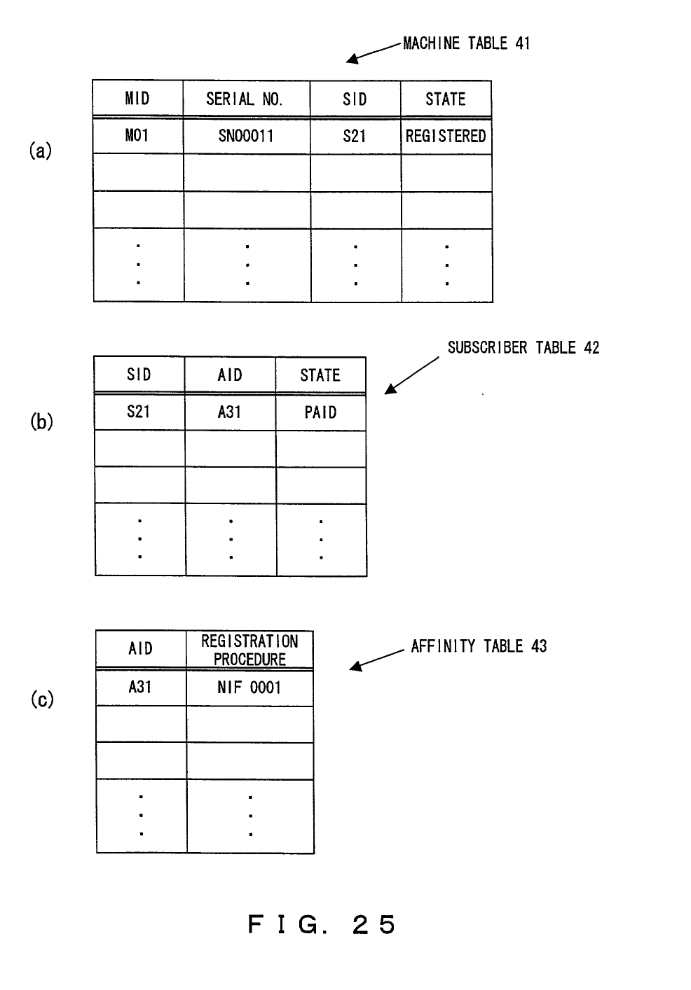

Shift the contents of the IA terminal user database 4 with which the IA terminal user management system 3 is provided to an “registered” state in step S230 (refer to FIG. 25).

After that, use ordinary service provided from ISP and ASP via the network 2 (step S231).

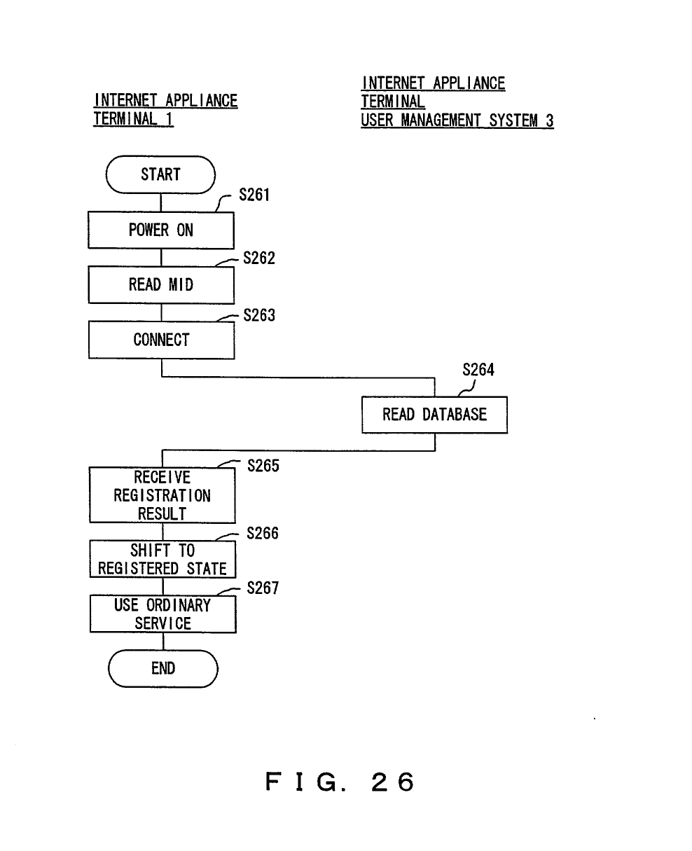

Described next is the breakdown replacement (breakdown replacement 1: SID input not required) which is the eighth embodiment to which the present invention applies with reference to FIG. 26 through FIG. 29.

FIG. 26 is a flowchart showing the flow of the registration processing of replacement due to breakdown (replacement 1: SID input not required).

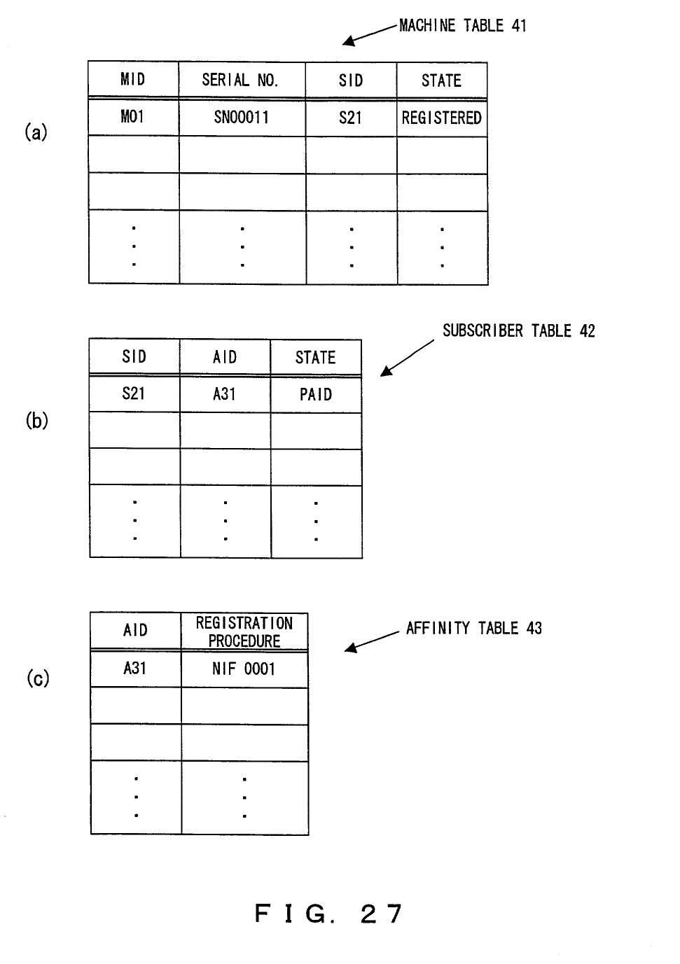

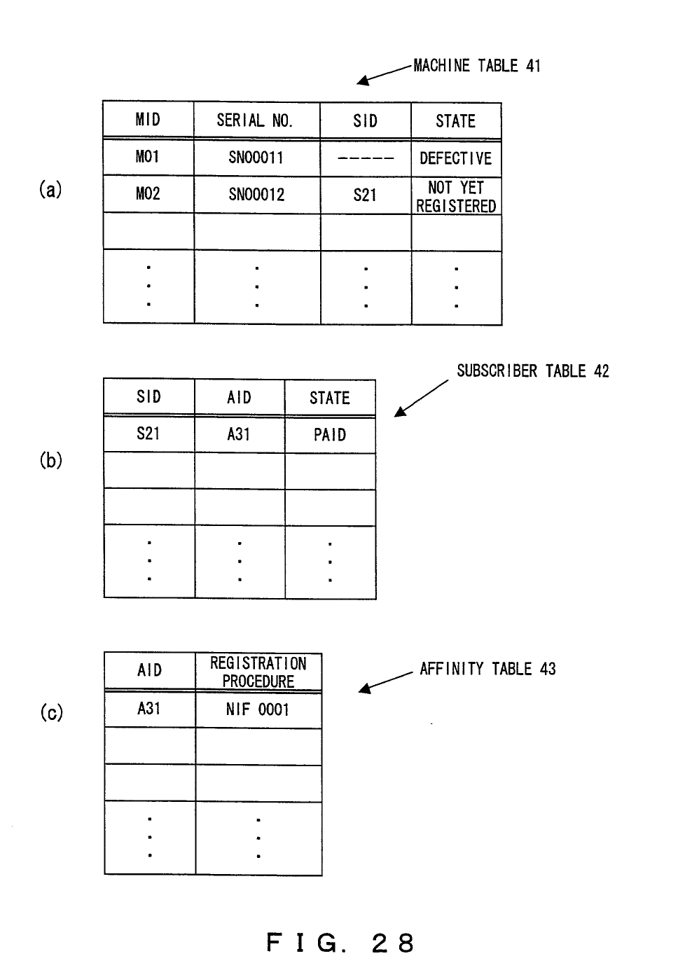

Prior to breakdown replacement (breakdown replacement 1: SID input not required), the IA terminal 1 is informed of old MID and new MID, changes the correspondence of old MID and SID (refer to FIG. 27) to the correspondence of new MID and SID (refer to FIG. 28), and changes the contents of the IA terminal user database to a “not yet registered” state.

First, turn on the power supply of the IA terminal 1 (ON) in step S261.

Since the registered flag stored in the internal memory of the IA terminal 1 has not been registered yet (e.g. 0 is stored), read the machine identifier (MID) given to uniquely identify the IA terminal 1 as hardware in step S262.

Connect the IA terminal 1 to the IA terminal user management system 3 in step S263.

Then, the IA terminal user management system 3 connected to the IA terminal 1 reads the IA terminal user database 4 (refer to FIG. 28) in step S264.

The IA terminal 1 receives the registration result from the IA terminal user management system 3 in step S265.

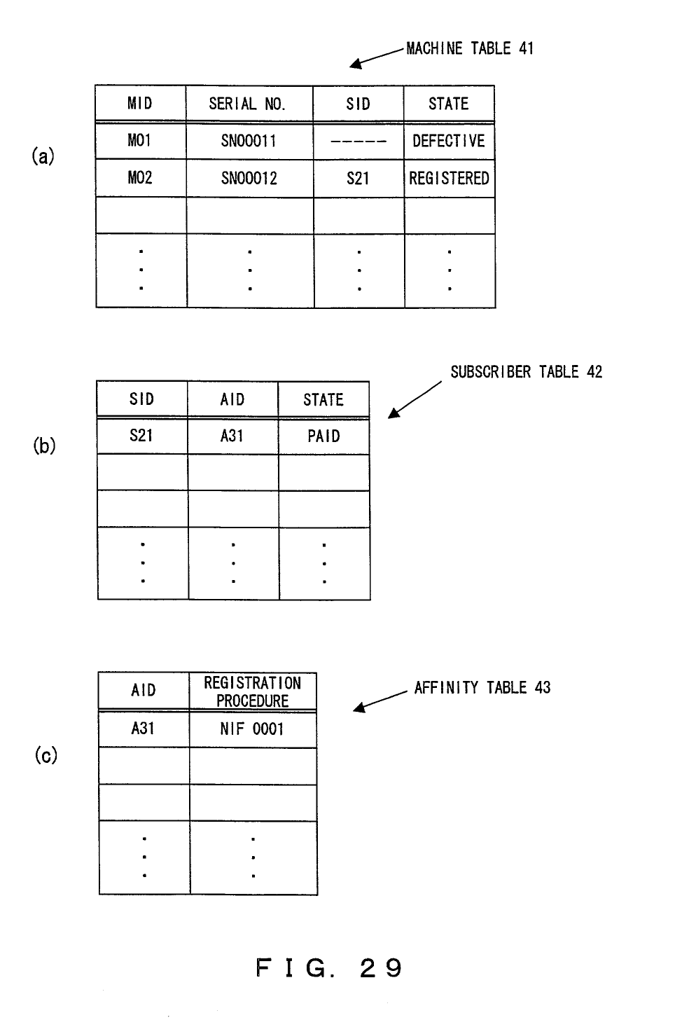

Shift the contents of the IA terminal user database 4 with which the IA terminal user management system 3 is provided to an “registered” state in step S266 (refer to FIG. 29).

After that, use ordinary service provided from ISP and ASP via the network 2 (step S267).

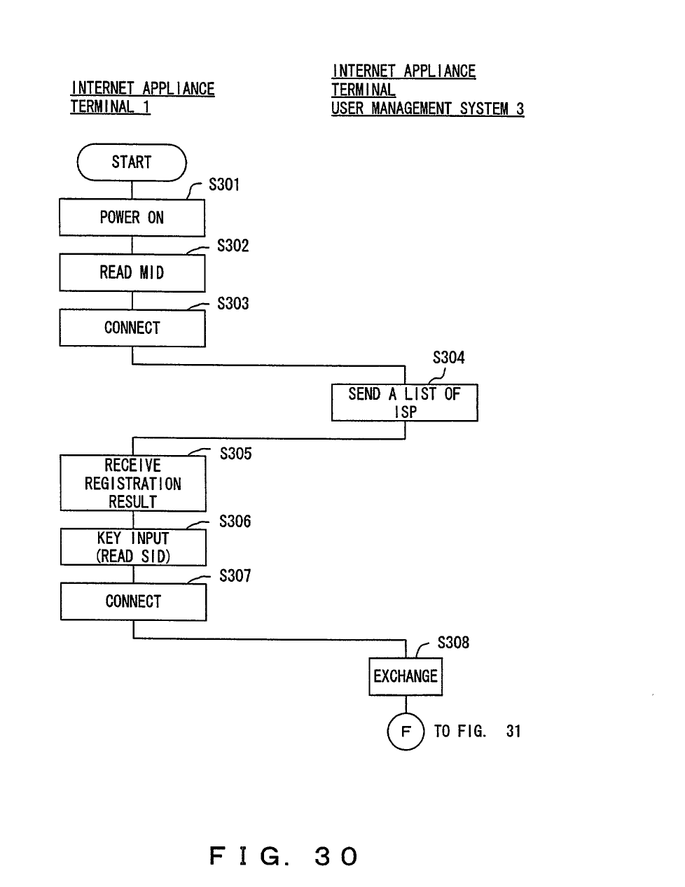

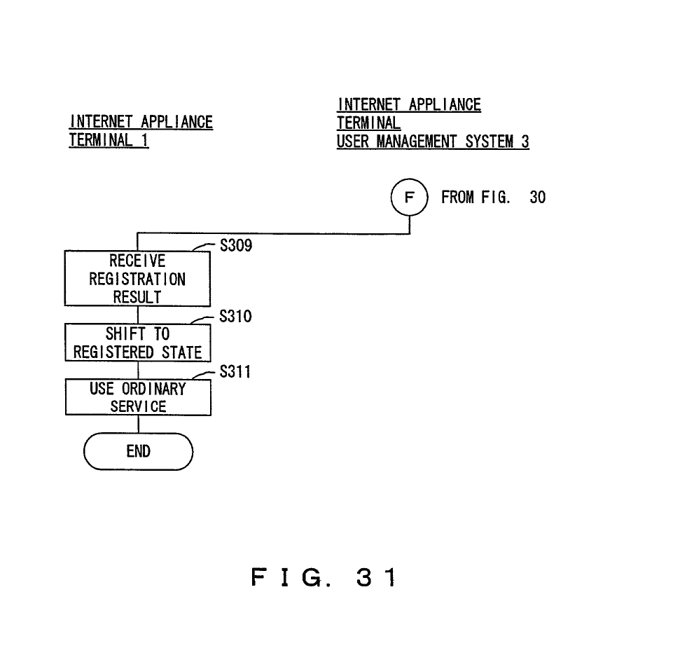

Described next is the breakdown replacement (breakdown replacement 2: SID input required) which is the ninth embodiment to which the present invention applies with reference to FIG. 30 and FIG. 31.

FIG. 30 and FIG. 31 are flowcharts showing the flow of the registration processing of replacement due to breakdown (replacement 2: SID input required).

First, turn on the power supply of the IA terminal 1 (ON) in step S301.

Since the registered flag stored in the internal memory of the IA terminal 1 has not been registered yet (e.g. 0 is stored), read the machine identifier (MID) given to uniquely identify the IA terminal 1 as hardware in step S302.

Connect the IA terminal 1 to the IA terminal user management system 3 in step S303.

Then, the IA terminal user management system 3 connected to the IA terminal 1 transmits a list of ISP to the IA terminal 1 in step S304.

The IA terminal user management system 3 connected to the IA terminal 1 receives the registration result (a list of ISP) from the IA terminal user management system 3 in step S305.

Since registration has not been completed yet, input insufficient data (AID) required for user registration from an input device such as a keyboard in step S306.

Connect the IA terminal 1 to the IA terminal user management system 3 again in step S307.

The IA terminal user management system 3 connected to the IA terminal 1 exchanges data concerning the IA terminal 1 in step S308.

In FIG. 31, the IA terminal 1 receives the registration result from the IA terminal user management system 3 in step S309.

Shift the contents of the IA terminal user database 4 with which the IA terminal user management system 3 is provided to a “registered” state in step S310.

After that, use ordinary service provided from ISP and ASP via the network 2 (step S311).

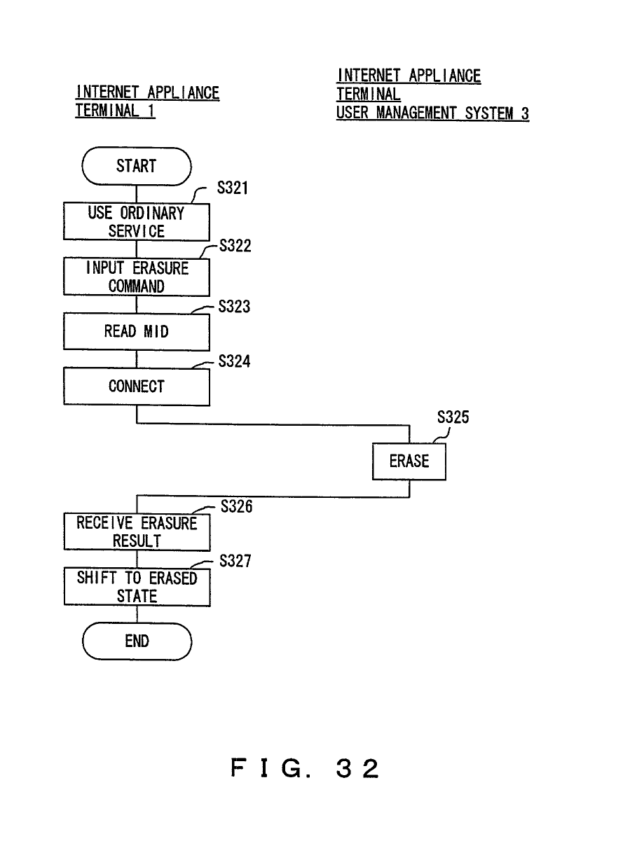

Described next is the registration erasure which is the tenth embodiment to which the present invention applies with reference to FIG. 32 through FIG. 34.

FIG. 32 is a flowchart (flowchart 2) showing the flow of the registration processing of registration erasure.

In registration erasure, all the information has already been registered, and MID has already been associated with SID.

Use ordinary service provided from ISP and ASP via the network 2 in step S321.

Input the command for erasing user registration in step S322, and read MID in step S323.

Connect the IA terminal 1 to the IA terminal user management system 3 in step S324, and transmit the erasure command inputted in step S322 and the MID read in step S323 to the IA terminal user management system 3.

Then, the IA terminal user management system 3 connected to the IA terminal 1 erases data concerning the IA terminal 1 in step S325 (receives MID, identifies SID, and erases MID and SID). Since the erasure result is transmitted from the IA terminal user management system 3, the IA terminal 1 receives the transmitted erasure result is step 326, and shifts the contents of the IA terminal user database 4 with which the IA terminal user management system 3 is provided to an “erased” state in step S327.

The embodiments of the present invention have so far been described referring to various drawings. The IA terminal 1 to which the present invention is applied, or the IA terminal user management system 3 to which the present invention is applied is, if its function can be executed, not limited to the embodiments described above, but can be a stand-alone apparatus, a system consisting of a plurality of apparatuses, an integrated system, or a system which executes processing via a network such as LAN and WAN.

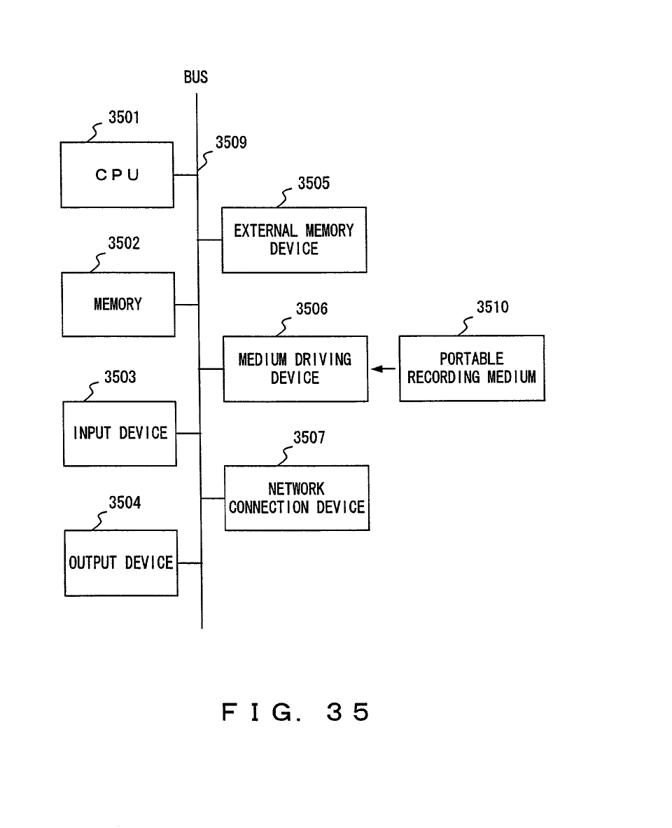

Also, the present invention can be realized by a system which comprises a CPU 3501 connected to a bus 3509, ROM and RAM 3502, an input device 3503, an output device 3504, an external recording device 3505, a medium driving device 3506, a portable recording medium 3510, and a network connection device 3507 as shown in FIG. 35. That is, it is needless to say that the function of the above-mentioned embodiments can be realized in such a manner that the ROM and RAM 3502, external recording device 3505, and portable recording medium 3510 which record the program record for realizing the systems of the embodiments described above are supplied to the IA terminal 1 or the IA terminal user management system 3, and the computer of the IA terminal 1 or the IA terminal user management system 3 reads and executes the program record.

In this case, the program record which is read from the portable recording medium 146, etc. realizes a new function of the present invention in itself, and the portable recording medium 3510, etc. which record the program record constitutes the present invention.

As a portable recording medium 3510 for supplying the program record, various recording media which record the program record can be used; for example, a flexible disc, a hard disc, an optical disc, a magnet-optical disc, CD-ROM, CD-R, DVD-ROM, DVD-RAM, a magnetic tape, a nonvolatile memory card, a ROM card, a network connection device 3507 such as electronic mail and personal computer communication (in other words, telecommunication lines).

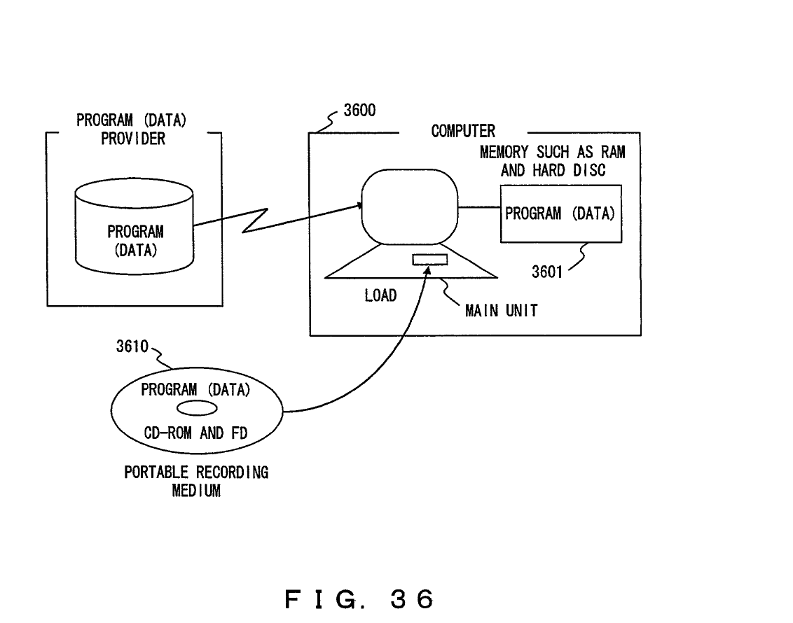

Not only the function of the above-mentioned embodiments is realized by executing the program record which the computer 3600 reads on the memory 3601 as shown in FIG. 36, but also the operating system which operates on the computer 3600 executes part or the whole of the processing based on the instructions of the program record, and the function of the above-mentioned embodiments is realized by said processing.

Also, the program code which has been read from the portable recording medium 3610 and the program (data) provided by a program (data) provider are read in the memory 3601 provided in an extended board inserted in the computer 3600 or in the memory 3601 provided in the function extension unit connected to the computer 3600, and then the function expansion board and the CPU provided in the function expansion unit execute part or the whole of the actual processing based on the instructions of the program record, thus causing the function of the above-mentioned embodiments to be realized.

That is to say, the present invention is not limited to the above-mentioned embodiments, but can be realized in various forms or constructions within the scope in which they do not exceed the concept of the present invention.

As has been explained, according to the present invention, a user who is not acquainted with an IA terminal or uses an IA terminal for the first time can easily register information of the user of the IA terminal in an Internet appliance user management system without changing the IA terminal and the software for controlling the IA terminal even if the distribution method of the IA terminal differs.

What is claimed is:

1. An Internet appliance user management system which is connected to an IA terminal via a network, comprising:
an IA terminal user storing unit storing IA terminal information including an IA terminal identifier for identifying the IA terminal, service information including the kind of service to be received, and user registration information including user information concerning the user who receives the service;
a transmission and receiving unit on the side of the IA terminal user management system, transmitting and receiving the user registration information to and from the IA terminal, and requests the IA terminal to input the user registration information;
a user registration information collation unit collating the user registration information received by the transmission and receiving unit on the side of the IA terminal user management system with the user registration information stored in the IA terminal user storing unit; and
an automatic registration unit obtaining the user registration information which has not been collated by the user registration information collation unit from the IA terminal by means of the transmission and receiving unit on the side of the IA terminal user management system and registering said information in the IA terminal user storing unit.

2. The IA terminal user management system according to claim 1, wherein
the transmission and receiving unit on the side of the IA terminal user management system receives user registration information including the IA terminal identifier from the IA terminal;
the user registration information collation unit collates the received user registration information with the user registration information stored in the IA terminal user storing unit;
the transmission and receiving unit on the side of the IA terminal user management system transmits the collated result to the IA terminal;
the transmission and receiving unit on the side of the IA terminal user management system receives additional user registration information which is not included in the received user registration information from the IA terminal; and
the automatic registration unit registers the received additional user registration information in the IA terminal user storing unit.

3. The IA terminal user management system according to claim 1, wherein the IA terminal user storing unit comprises:
a machine table which stores the IA terminal identifier in association with a user identifier for identifying the user;
a subscriber table which stores the user identifier in association with a service provider identifier for identifying the service provider who provides the service; and
an affinity table which stores the service provider identifier in association with the registration procedure for registering the user determined by the service provider.

4. The IA terminal user management system according to claim 2, wherein the IA terminal user storing unit comprises:
a machine table which stores the IA terminal identifier in association with a user identifier for identifying the user;
a subscriber table which stores the user identifier in association with a service provider identifier for identifying the service provider who provides the service; and
an affinity table which stores the service provider identifier in association with the registration procedure for registering the user determined by the service provider.

5. The IA terminal user management system according to claim 1, wherein the automatic registration unit erases the user registration information stored in the IA terminal user storing unit.

6. The IA terminal user management system according to claim 2, wherein the automatic registration unit erases the user registration information stored in the IA terminal user storing unit.

7. The IA terminal user management system according to claim 3, wherein the automatic registration unit erases the user registration information stored in the IA terminal user storing unit.

8. The IA terminal user management system according to claim 4, wherein the automatic registration unit erases the user registration information stored in the IA terminal user storing unit.

9. The IA terminal which performs information communication via a network, comprising:
a transmission and receiving unit on the side of the IA terminal, transmitting and receiving IA terminal information including an IA terminal identifier for identifying the IA terminal, service information including the kind of service to be received, and user registration information including user information concerning the user who receives the service to and from the IA terminal user management system which manages the IA terminal via the network; and
an input unit inputting insufficient user registration information based on the request of the IA terminal user management system;
whereas the transmission and receiving unit on the IA terminal transmits the user registration information inputted by the input unit to the IA terminal user management system.

10. The IA terminal according to claim 9, wherein
the transmission and receiving unit on the side of the IA terminal transmits user registration information including the IA terminal identifier to the IA terminal user management system;
the transmission and receiving unit on the side of the IA terminal receives the result of having collated the transmitted user registration information and the user registration information stored in the IA terminal user storing unit with which the IA terminal user management system is provided;
the input unit inputs additional user registration information which is not included in the received user registration information; and
the transmission and receiving unit on the side of the IA terminal transmits the inputted additional user registration information to the IA terminal user management system.

11. An IA terminal user management program which makes a computer with which the IA terminal user management system managing the IA terminal connected via a network is provided realize:
the function which stores, in a database, IA terminal information including an IA terminal identifier for identifying the IA terminal, service information including the kind of service to be received, and user registration information including user information concerning the user who receives the service;
the function which transmits and receives the user registration information to and from the IA terminal, and requests the IA terminal to input the user registration information;
the function which collates the received user registration information with the user registration information stored in the database; and
the function which obtains the user registration information which is not collated by the collating function from the IA terminal, and automatically registers said information in the database.

12. The IA terminal user management program according to claim 11, wherein
the function which transmits and receives the user registration information and requests the IA terminal to input the user registration information receives user registration information including the IA terminal identifier from the IA terminal;
the collating function collates the received user registration information with the user registration information stored in the database;
the function which transmits and receives the user registration information and requests the IA terminal to input the user registration information transmits the result of having collated said information to the IA terminal; and
the function which transmits and receives the user registration information and requests the IA terminal to input the user registration information receives additional user registration information which is not included in the received user registration information from the IA terminal, and the automatically registering function registers the received additional user registration information in the database.

13. The IA terminal user management program which makes a computer with which the IA terminal performing information communication via a network is provided realize:
the function which transmits and receives IA terminal information including an IA terminal identifier for identifying the IA terminal, service information including the kind of service to be received, and user registration information including user information concerning the user who receives the service to and from the IA terminal user management system which manages the IA terminal via a network; and
the function which inputs insufficient user registration information based on the request of the IA terminal user management system;
whereas the transmission and receiving function transmits the inputted user registration information to the IA terminal user management system.

14. The IA terminal user management program according to claim 13, wherein
the transmission and receiving function transmits user registration information including the IA terminal identifier to the IA terminal user management system;
the transmission and receiving function receives the result of having collated the transmitted user registration information with the user registration information stored in the database with which the IA terminal user management system is provided from the IA terminal user management system;
the input function inputs additional user registration information which is not included in the received user registration information; and
the transmission and receiving function transmits the inputted additional user registration information to the IA terminal user management system.

15. An Internet appliance user management system which is connected to an IA terminal via a network, comprising:
IA terminal user storing means for storing IA terminal information including an IA terminal identifier for identifying the IA terminal, service information including the kind of service to be received, and user registration information including user information concerning the user who receives the service;
transmission and receiving means for on the side of the IA terminal user management system, transmitting and receiving the user registration information to and from the IA terminal, and requests the IA terminal to input the user registration information;
user registration information collation means for collating the user registration information received by the transmission and receiving means on the side of the IA terminal user management system with the user registration information stored in the IA terminal user storing means; and
automatic registration means for obtaining the user registration information which has not been collated by the user registration information collation means from the IA terminal by means of the transmission and receiving means on the side of the IA terminal user management system and registering said information in the IA terminal user storing means.

16. The IA terminal which performs information communication via a network, comprising:
transmission and receiving means for on the side of the IA terminal, transmitting and receiving IA terminal information including an IA terminal identifier for identifying the IA terminal, service information including the kind of service to be received, and user registration information including user information concerning the user who receives the service to and from the IA terminal user management system which manages the IA terminal via the network; and
input means for inputting insufficient user registration information based on the request of the IA terminal user management system;
whereas the transmission and receiving means on the IA terminal transmits the user registration information inputted by the input means to the IA terminal user management system.
